(19) United States
(12) Patent Application Publication
(10) Pub. No.: US 2026/0276863 A1
(43) Pub. Date: Sep. 17, 2026

(54) CATALYTIC METAMATERIAL ABSORBER-EMITTER, DEVICES AND METHODS OF FABRICATION AND APPLICATIONS THEREOF

(71) Applicants: Joel Yi Yang LOH, Toronto (CA); Mahdi SAFARI, Toronto (CA); Nazir Pyarali KHERANI, Toronto (CA); Edgar ACOSTA, Toronto (CA)

(72) Inventors: Joel Yi Yang LOH, Toronto (CA); Mahdi SAFARI, Toronto (CA); Nazir Pyarali KHERANI, Toronto (CA); Edgar ACOSTA, Toronto (CA)

(21) Appl. No.: 19/682,789

(22) Filed: May 20, 2026

Related U.S. Application Data
(62) Division of application No. 17/896,764, filed on Aug. 26, 2022.
(60) Provisional application No. 63/237,695, filed on Aug. 27, 2021.

(51) Int. Cl. G02B 1/00; G02B 5/00

(52) U.S. Cl. CPC G02B 1/002; G02B 5/003

(57) ABSTRACT

Devices and methods are disclosed for near unity absorption or near zero reflection of electromagnetic radiation over a wide range of wavelengths, omnidirectionally and that use the absorbed radiation to enhance the catalysis conversion of reactant chemicals to product chemicals of interest via the patterning of subwavelength metamaterial elements as a surface, or colloidal clusters of subwavelength particles as a suspension. The arrangements, dimensions, materials and geometries of the unit elements of the meta-surface or colloidal clusters may be selected to produce an effective refractive index lower than that of the refractive index of the comprising materials, such that the effective index approaches the index of the surrounding medium. Impedance matching, plasmonic modes between the metamaterial elements or cluster nanoparticles, ohmic material losses, and bandgap absorption may be combined to achieve broadband near-unity absorption and/or modulated thermal emission bands, enhancing the catalysis rates of gas, liquid and multi-phase chemical reactions.

### CROSS-REFERENCE TO RELATED APPLICATIONS

This application claims priority to U.S. Provisional Patent Application No. 63/237,695, titled “CATALYTIC METAMATERIAL ABSORBER-EMITTER, DEVICES AND METHODS OF FABRICATION AND APPLICATIONS THEREOF” and filed on Aug. 27, 2021, the entire contents of which is incorporated herein by reference.

### BACKGROUND

The present disclosure relates to metamaterials. More particularly, the present disclosure relates to metamaterials for chemical photocatalysis, thermocatalysis, photoelectrocatalyis and electrocatalysis.

Efficient, reliable and economic devices that enable efficacious catalytic conversion of solar energy into solar fuels are critical to advancing the vision of a renewable sustainable economy. Rapid advances in technology are enabling the engineering of light-matter interactions with potentially far-reaching implications to address major global challenges pertaining to sustainable energy and climate change. The development of the closed-carbon fuel cycle is one of the promising solutions for these challenges, wherein for example solar powered reduction of CO₂ leading to production of methanol can contribute to the production of solar fuels. Another example is solar powered reduction of CO₂ to produce a manifold of carbonaceous feedstock for various chemical production processes. Yet another example is solar powered dissociation of water to produce hydrogen as a clean solar energy vector. In all, solar powered catalysis promises to reduce thermal power requirements and enable new catalytic pathways over a large library of photocatalyst material candidates. Over the past few decades there has been a growing focus to develop and perfect various photocatalytic, thermocatalytic, photoelectrocatalytic, electrocatalytic material systems for CO₂ reduction, hydrogen generation and other useful chemical reactions [1-5].

With an eye to availing the essentially everlasting limitless source of non-polluting solar radiant energy, various studies propose different catalytic materials to absorb the sunlight and thereby convert solar energy into solar fuels with the objective of enhancing the efficiency of the catalytic reaction-both photon to product conversion efficiency and reaction kinetics under a range of light intensities and photo-induced temperature or reactor heating. Different chemical processes have been exploited to utilize and optimize catalytic material systems for this purpose. However, many high performing catalytic materials absorb a small percentage of the light source, such as 5% of the UV component of the solar spectrum [6]. In addition, random distribution of powders, plasmonic nanostructures, and catalytic nanoparticles on a surface or in a solution result in scattering losses and reduction in the catalytic efficiency since not all particles are uniformly illuminated. This difficulty makes the implementation and scale up of efficient photoreactor designs a challenge. There are examples of simplified radiation flux models that can be applied to a wide variety of photoreactor designs, but the models are limited to a catalyst scattering albedo lower than 0.3 [7, 8]. Therefore, geometrical design and distribution of nanocatalytic particles both in a layered format and suspensions of a realistically non-uniformly sized particulate catalyst opens a pathway to design catalytic materials with higher degrees of freedom to achieve low to zero scattering coefficients which will be a significant benefit to designing high kinetic efficiency photoreactors.

To address some of these issues, photonic crystals [9], nanoparticles [10], plasmonic nanostructures have been studied extensively to enhance the efficiency of light absorption in catalytic materials. While plasmonic structures are helpful for increasing the carrier density and high local field intensities at the surface, owing to their limitations vis-à-vis absorption of limited frequency bandwidths, restricted incident angle ranges and high scattering losses, they are not deemed to be capable of exploiting the sunlight energy to the fullest—that is, wideband wide-angle total absorption of light. Efforts have been made to enhance the bandwidth of the absorption in plasmonic structures for various applications, but these materials have not been utilized for photocatalytic applications.

On the other hand, the field of metamaterials—material systems comprising subwavelength elements capable of manipulating electromagnetic wave—matter interaction, has been explored widely to achieve exotic electromagnetic responses which are otherwise absent in nature; these include, cloaking [12], negative refractive index [13], lasing [14], artificial magnetism [15], acoustic [16] and mechanical metamaterials [17], hyperbolic metamaterials [18] and perfect optical absorbers [19]. Further, metasurfaces permit engineering of the electromagnetic response (electric permittivity (ε) and magnetic permeability (μ)) through subwavelength patterning of a given surface [20]. Moreover, while optical losses are a major limitation in various devices, certain applications benefit from light absorption. Therefore, it is useful to enhance optical absorption through various approaches such as impedance matching [21], plasmonic absorption [22], and resonant absorption [23]. Through these approaches, it has been shown that by using metasurfaces it is possible to achieve near-unity absorption by virtue of impedance matching and reducing the reflection. Metasurfaces can also be patterned to modulate emission bands in electromagnetic wavelength regions of interest.

The name “near-unity metamaterial absorber” is commonly used in the literature for metamaterial structures with zero reflection and transmission coefficients at normal incidence. This terminology is rather limiting and practically unrealistic considering the fact that in the case of the ‘ideal absorber’ design, perfect normally refers to all-frequency all-angle total absorption independent of the polarization of the incident wave. Hence, in the quest for the ‘ideal’ absorber, the term ‘low refractive index near-unity omnidirectional’ metamaterial absorber is employed. So-called perfect metamaterial absorbers have been used for various applications such as bio-sensing [24], photovoltaics [25], photodetectors [26, 27]. However, most of the mentioned studies remain theoretical and lack experimental demonstration or the designed structure simply achieves total absorption over a certain bandwidth and under normal incidence.

Unlike chemically processed materials and plasmonic absorbers, metamaterial designs focus mainly on the geometry and position of the nanoparticles/nanoelements to mitigate/remove the scattering losses associated with the plasmonic structure giving rise to near-unity wideband wide-angle absorption of the incident light independent of the polarization. In addition to harvesting a large range of incident wavelengths or frequencies, metamaterials can induce concentrated electrical and magnetic fields in order to enhance the thermodynamics or kinetic aspect of catalysis reactions. Moreover, metasurfaces are the 2-dimensional counterpart of metamaterials with expectedly lower weight, lower losses, and simpler fabrication which thus could be the solution to the problem of achieving thin, highly efficient, and all-angle absorbing, compact photovoltaic and photochemistry cells.

### SUMMARY

Devices and methods are disclosed for near unity absorption or near zero reflection of electromagnetic radiation over a wide range of wavelengths, omnidirectionally and that use the absorbed radiation to enhance the catalysis conversion of reactant chemicals to product chemicals of interest via the patterning of subwavelength metamaterial elements as a surface, or colloidal clusters of subwavelength particles as a suspension. The arrangements, dimensions, materials and geometries of the unit elements of the meta-surface or colloidal clusters may be selected to produce an effective refractive index lower than that of the refractive index of the comprising materials, such that the effective index approaches the index of the surrounding medium. Impedance matching, plasmonic modes between the metamaterial elements or cluster nanoparticles, ohmic material losses, and bandgap absorption may be combined to achieve broadband near-unity absorption and/or modulated thermal emission bands, enhancing the catalysis rates of gas, liquid and multi-phase chemical reactions.

Further, the thermal emission from the surface is engineered to suppress unwanted emission, accordingly increasing the temperature of the catalyst and emitting in certain bandwidth(s) to enhance exciting the vibrational modes of specific chemical species and in turn increasing the selectivity and reaction rate(s).

The material composition and layer combinations of the unit elements may be selected to optimize thermal, optical, electronic behavior in order to increase or maximize the selectivity and reactivity of chemical reactions, and thus resulting in optimal consumption/production rates of the chemical species. In this manner, it is possible to tune the optical or electromagnetic properties of an active catalytic material by optimizing its geometry and arrangement without changing its material composition, thus resulting in a catalytic metamaterial that has high photo-active, thermo-active, and electro-active catalysis behavior. Various examples of catalytic metamaterials, methods and implementations thereof are disclosed.

The present disclosure provides a variety of geometric structures that in turn consist of an ordered or disordered collection of geometric and material elements, which comprise of catalytic and catalytic-enhancing materials to drive catalysis of reactant molecules, as well as act as an optical metamaterial with near-unity optical absorption over a wide range of incident angles (0-70° from the normal) and a large wavelength range (300-5000 nm).

Some aspects of the present disclosure generally relate to a catalytic metamaterial or a meta-catalyst. The catalytic metamaterial consists of sub-wavelength structures (i.e., meta-atoms) that receive electromagnetic radiation or light illumination that enable optical, electronic, thermal, and chemical functionalities that are not seen in conventionally applied optical designs, and not seen in conventionally designed catalytic structures and materials.

Accordingly, in one aspect, there is provided a metamaterial structure for catalytic applications wherein the metamaterial structure is a metasurface that comprises:
a rigid or flexible dielectric or metallic substrate; (thickness>0.5 μm, material);
a thin metallic or semiconductor layer, which is optically reflective, is layered upon the dielectric or metallic substrate;
a periodic ensemble of materials-based elements, layered upon the metallic or dielectric layer, where the element(s) has (have) a defined geometric construct(s) that results in a specific nano-array;
wherein the individual array elements in the nano-array are appropriately configured, in terms of composition, shape, relative distribution and areal density, so as to result in an engineered effective refractive index, for the entire/composite metasurface structure, that matches the refractive index of the medium adjacent to the metasurface;
wherein the individual array elements are distributed so that they can have plasmonic interactions through the edges and corners of their geometries;
wherein the nano-array is also appropriately configured so as to result in an engineered metasurface that exhibits near-unity optical electromagnetic absorption (impedance matching) of light ranging over a broadband of wavelengths, wide range of incident angles, and range of electromagnetic polarization; and/or near unity thermal associated narrowband emission;
wherein the metasurface configuration permits both electrical and thermal transport between the nano-array and the underlying metallic layer; and
wherein the selected materials comprising the metasurface are selected for driving specific catalytic reactions in an electronic and/or thermal approach.

Each unit of metamaterial element can comprise two or more layers that each enables at least one functionality. One material form is to generate optical absorption over a range of wavelengths and incident angles through multilayer metal-dielectric stack design based on the interference effect. The second functionality is to use a metamaterial design based on electrical and magnetic resonances to generate thermal emission of a pre-determined bandwidth over a range of angles of emission through patterning of the multilayer stack.

Each unit of metamaterial element can comprise various layers that enable electronic functionalities to emerge.

Each unit of metamaterial element comprises a multilayer design that enables suppressing thermal emission in the undesired bandwidth, trapping the heat within the catalyst thus resulting in higher temperature, which in turn leads to higher reaction rates.

Each unit of metamaterial element comprises a multilayer design, that along with the geometrical properties of the element enable emission in a certain bandwidth corresponding to the specific vibrational modes of the desired reactant species (inside the bulk of the fluid flow) in order to destabilize the desired bonds of the species so as to enhance the reaction rate, selectivity, and reducing the probability of reverse reactions.

Metamaterial elements that can enable plasmonic response in the IR range in order to enhance the localized field intensity over the desired wavelength(s) so as to excite the vibrational modes of the desired reactant species and in turn destabilizing the desired bond which increases the reaction rate, selectivity, and reduces the probability of reverse reactions.

Metamaterial gratings with appropriate cavity size (width and depth) enables engineering of the plasmonic resonances to match the vibrational modes of the chemical reactant's bonds. High field intensity up to 1×10¹² V/m destabilizes the bonds and increases the reaction rate while enhancing the selectivity and reducing the reverse reaction rates.

Doped semiconductors, examples such as ITO, Si, ZnO, VO₂, can be used to induce plasmonic responses in the IR range matching the reactant's bond energy to destabilize the bonds using localized high field intensity up to 1×10¹² V/m.

In another aspect, there is provided a colloidal metamaterial assembly that enables low scattering losses from incident photo-illumination and comprises catalytic materials for enabling catalytic conversion rates of reactant molecules into product molecules of interest, under photo-illumination. The colloidal metamaterial assembly generally comprises:
a plurality of electric and magnetic resonance elements arranged in a larger structure or cluster;
wherein the distribution of clusters is in a liquid or aqueous medium;
wherein the distribution can be periodic or randomized;
wherein the ensemble of similar geometric and material defined clusters and their interactions give rise to electromagnetic properties;
which enables intense electric and magnetic fields to be set up within the cluster based on the plasmonic effect;
such that the effective index of the entire system (i.e., solution) approaches that of the surrounding medium;
which enables minimization of optical scattering of each individual cluster.

In another embodiment, the photocatalytic metamaterial is comprised of assembled colloidal particles of metal or metal oxides or ceramics embedded in a polymer mesh network produced by the assembly of surfactants, amphiphilic block copolymers or mixing thereof;
the geometric array of such assembly is further controlled by the composition of the liquid crystal, microemulsion, or block copolymer mixture used to produce the colloidal array;
such that the effective index of the entire volume of metamaterial clusters and polymer mesh approaches that of the surrounding medium.

A further understanding of the functional, advantageous, and design aspects of the disclosure can be realized with reference to the following detailed descriptions and embodiments.

### BRIEF DESCRIPTION OF THE DRAWINGS

Embodiments will now be described, by way of example only, with reference to the drawings, in which:

FIGS. 1A-1D are illustrations of a square lattice metasurface, with periodic arrays of metamaterial elements including but not limited to cubical or hexagonal, cylindrical or cross-shaped geometries. The metamaterial elements can comprise 1 to 3 layers, or more than 3 layers, wherein each layer could comprise of a single or a plurality of sublayers, that are composed of metallic and semiconductor elements or compounds that achieve electronic or catalytic functionalities.

FIG. 1E is an illustration of the cross section of a metasurface comprising a dielectric or metallic substrate, adjacent to a metallic reflective film, and adjacent to the periodic array of metamaterial elements of 3 layers.

FIG. 1F is an illustration of the various lattice types possible in a metasurface such as hexagonal, square, centred-rectangular, oblique lattice.

FIGS. 2A and 2B are illustrations of electrical and magnetic currents set up in an individual metamaterial element under light radiation. A meta-atom suitable for broadband absorption and a metamaterial element suitable for modulating thermal emission is shown in 2A and 2B respectively.

FIG. 2C illustrates the emission spectrum of a blackbody absorber.

FIG. 2D illustrates the emission spectrum of a metamaterial thermal emitter.

FIGS. 3A and 3B are illustrations of photo illuminated reactors that contain the metamaterial performing a gas phase catalysis reaction. A batch reactor is shown in FIG. 3A to illustrate the basic concept of the catalytic metasurface. A flow reactor is shown in FIG. 3B to illustrate how reactant flow across the metasurface and light illumination results in product flow which is suitable for compact modular panels.

FIG. 4 shows a metasurface that is decorated with molecular catalysts or nanoparticle catalysts that are substantially smaller than the metamaterial element. The electric fields generated by the metamaterial elements under illumination are coupled and concentrated together to enhance the electric field on the decorated particles.

FIGS. 5A-5D show various specialized configurations of metasurface designs that facilitate, enhance or optimize charge separation, charge transfer, optical absorption and thermal aspects of catalytic reactions.

FIG. 6A shows how charge separation within the metamaterial element under illumination results in holes transferring to the top layer of the element and electrons transferring to the bottom of the substrate where another catalytic layer is adjacent.

FIG. 6B shows how engineered thermal emission from a metamaterial element interacts with the vibrational modes of a molecule.

FIG. 6C is an illustration of a metamaterial structure that possesses plasmonic response in the IR region designed to enhance the localized field intensity in the specific band.

FIG. 7 is an illustration of the electrical and magnetic resonance set up in a metamaterial cluster for the purpose of colloidal metamaterials.

FIG. 8A is an illustration of various arrangements of metamaterial clusters, suspended randomly in a liquid or aqueous medium.

FIG. 8B is an illustration of two types of photocatalytic clusters composed of different catalytic materials, that are suspended in solution or distributed on a substrate in a solution.

FIG. 9 is an illustration of an approximately periodic arrangement of metamaterial clusters affixed to a polymer mesh, suspended in liquid or aqueous medium.

FIGS. 10A and 10B provide illustrations of various core-shell configurations of the metamaterial cluster elements, that facilitate, enhance or optimize electronic and optical functionalities.

FIGS. 11A and 11B are scanning microscopy images of an example of a copper/zinc oxide metasurface suitable for carbon dioxide hydrogenation into methanol.

FIGS. 12A and 12B show the optical absorption spectrum of the copper/zinc oxide metasurface, as simulated, and experimentally determined, in comparison with a copper/zinc oxide film of the same thicknesses.

FIG. 13A shows the effective refractive index of the copper/zinc oxide metasurface on the basis of an analytical Effective Medium Theory approach.

FIG. 13B shows calculated optical absorption spectrum of such an effective index layer and the experimental absorption spectrum of a surface of lattice arranged copper/zinc oxide structures that have significant dimensional deviations from the as designed metasurface.

FIG. 13C shows the scanning microscopy image of the deviated sample.

FIG. 14A shows the simulated electric field distribution of a unit cell of the copper/zinc oxide metasurface at various incident wavelengths.

FIG. 14B shows the volumetric averaged electric field intensities of the copper/zinc oxide metasurface over the optical spectrum.

FIGS. 15A and 15B show the simulated cross-sectional view of the electric field distribution of the copper/zinc oxide metasurface at various incident wavelengths under transverse electric and transverse magnetic polarization modes, respectively.

FIG. 16A shows the methanol production rate under dark and under photo-illumination on the copper/zinc oxide metasurface, and a uniform copper/zinc oxide film on quartz fiber substrate.

FIG. 16B shows the ¹³C isotope methanol validation through mass spectroscopy in comparison with that of a ¹³C methanol standard.

FIGS. 17A-17D show the angular incidence dependent variation in absorption grayscale plot of the copper/zinc oxide metasurface in comparison with that of a copper and of a copper/zinc oxide uniform film, under Transverse Electric (FIG. 17A, FIG. 17C) and Transverse Magnetic (FIG. 17B, FIG. 17D) polarization.

FIG. 18 shows the simulated and experimentally derived optical absorption spectroscopy of the copper/zinc oxide metasurface at various selected incident angles.

FIG. 19 shows the methanol production rate of the copper/zinc oxide metasurface and of the copper/zinc oxide uniform film, at varying incident angles, normalized against the methanol production rate at a normal incident angle of light.

FIGS. 20A and 20B show two types of metamaterial structure periodic elements that are engineered to emit in a narrowband that can couple to the vibrational mode of CO₂ molecules.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

Unless defined otherwise, all technical and scientific terms used herein are intended to have the same meaning as commonly understood to one of ordinary skill in the art. Unless otherwise indicated, such as through context, as used herein, the following terms are intended to have the following meanings:
As used herein, the term “dielectric” refers to any polarizable non-conductive medium, including air.
As used herein, the term “catalyst” refers to any material that can chemisorb reactant molecules and chemically convert them into product molecules.
As used herein, the term “co-catalyst” refers to any material that can assist or enhance catalysis rate of the catalyst material.
As used herein, the term “photocatalyst” refers to any material that can absorb light and either generate charge carriers that will enable the conversion of reactant into product molecules, or absorb light to generate heat as a “photothermal catalyst” which will enhance the kinetics of the conversion of reactants into product molecules.
As used herein, the phrase “subwavelength” refers to a feature having a characteristic size or dimension that is less than the free-space wavelength of light that is incident on a device or structure.
As used herein, the term “metasurface” refers to a surface, such as a planar surface, that has electromagnetic meta-atoms that have a specific geometry and size, in order to achieve a wide band optical absorption as well as electromagnetic resonances in the locality of the metamaterial elements.
As used herein, the term “metamaterial elements” and “meta-atoms” refer to the electromagnetic elements that are arrayed on a surface, to comprise as a metasurface. Each metamaterial element has catalytic abilities. A metamaterial element has sub-wavelength dimensions, that is, characteristic dimensions such as height, width and/or diameter, that is smaller than a prescribed operating minimum wavelength of incident light.
As used herein, the term “layer” refers to the various divisions in a single metamaterial element, that comprises different material compositions or material stoichiometries. These layers may assist or drive catalysis or display a functionality that is associated with chemical reactions thermodynamics or facilitate, enhance or optimize mass transfers. A given layer may include a plurality of sub-layers.
As used herein, the term “plasmonic” refers to resonant oscillation of free electron density in the metallic portion of a metamaterial structure. The term also applies to doped semiconductors with a free electron/charge density that will support their resonant oscillation.
As used herein, the term “cavity modes” refers to the intense electric or magnetic resonance set up between each pair of metamaterial elements within a metasurface.
As used herein, the term “localized surface plasmonic resonances” or refers to the intense electric fields located at sharp discontinuities of the metamaterial element such as corners, edges or steps.
As used herein, the term “hot spots” refers to the intense electric or magnetic fields residing within a metamaterial cluster or meta-atom.
As used herein, the term “cluster element” refers to plurality of particles that collectively form a metamaterial cluster of a colloidal metamaterial. The arrangement of several nanoparticles in a cluster element results in the generation of electromagnetic hot spots under incident light. The collection of several cluster elements, suspended in a liquid or aqueous medium, forms a colloidal metamaterial.
As used herein, the term “hot electrons” refers to highly energetic free electrons that are ejected from high intensity plasmonic resonances of a material, that can subsequently be injected into an unoccupied molecular orbital of an adjacent atom or molecule, which typically refers to the reactant molecule of interest.
As used herein, the phrase “catalytic material” refers to a solid material with a composition comprising at least one of a metal, metal oxide, metal nitride, metal sulphides, semiconductor, semiconductor compound. The catalytic material may be provided in one or more in discrete layers. The function of the catalytic material is to chemically activate reactant molecules under thermal and/or photo conditions to convert one or more reactants into products. Catalytic function may include conversion via a photo-excited charging or thermal agitation of molecules/atoms that are absorbed onto the surface of the catalytic material.
As used herein, the terms “perfect optical absorber” and “near-unity absorption” refers to exhibiting absorption of at least 80% of the incident light, at least at normal incidence. In some cases, a perfect optical absorber or near-unity absorber may exhibit optical absorption of at least 65% for angles of incidence between 0 to 55 degrees from normal incidence.
As used herein, the term “wide band” refers to an optical wavelength range of at least 100 nm.
As used herein, the term “impedance matched”, when employed to refer to a metamaterial catalyst surface or metamaterial catalytic colloid, refers to an approximate equivalence of the effective optical refractive index of the metamaterial catalyst, with the refractive index of the surrounding environment, over a prescribed wavelength range. For example, the ratio of the surrounding refractive index to the effective refractive index of the metamaterial catalyst, across a wavelength range of interest of at least 100 nm, may range between 0.5 and 2.
As used herein, the phrase “sub-wavelength” is made with reference to a reference incident wavelength within a material or medium adjacent to a metamaterial catalyst. For example, in implementations in which it is desirable to achieve optical absorption over the visible spectrum, the term “sub-wavelength” means smaller than 400 nm. In another example, in implementations in which it is desirable to achieve optical absorption over the mid-infrared spectrum, sub-wavelength means smaller than 2000 nm.

### Catalytic Metasurfaces

The present disclosure describes sub-wavelength lattice metamaterials for absorbing a large range of wavelengths with near-unity absorption through mitigation of scattering losses by virtue of impedance matching and effective parameter engineering of the metasurface structure and thus generating high electric and magnetic fields in the locality of the metamaterial.

In various embodiments the metamaterial structures that are described include an underlying film, and several geometric shapes of electrical and magnetic resonators that are spatially arranged to achieve impedance matching between the metamaterial device and the surrounding medium. The impedance matching also supports the coupling of electromagnetic waves in order to generate cavity modes (cavity modes refer to standing waves of electrical or electromagnetic fields within the gap of two metamaterial structures) between the resonators.

The electrical and magnetic metamaterial elements can comprise catalytic materials, thus serving a dual purpose of optical absorption and resonance, as well as performing catalysis. The catalysis reaction may be enhanced due to the broadband optical absorption and the presence of cavity modes that arise from the geometry, dimensions and arrangement of the metamaterial elements. The metamaterial properties are generally facilitated by a combination of structure and geometry, involving the modification of existing materials and compositions towards optical absorption and other effects. The materials in this case are all associated with catalytic or enhancing catalysis materials of specific reactions. As example of common catalytic metals, Nickel, Copper, Silver, Platinum, Aluminum, Tin, Zinc, Titanium, Lead, Iron and less common (because more expensive) Indium, Tungsten, Gallium, palladium, cobalt, molybednum, Manganese, Vanadium, Bismuth, Ruthenium can be used in the metamaterial catalysis approach. The Oxides, Nitrides and Sulphides of the above mentioned metals can also be part of the metamaterial structures to further enhance the catalysis. Semiconductors can also be used in metamaterial such as Silicon, Germanium, Gallium, Arsenide, Selenide, Antimony, and their compounds involving either these semiconductors (GaAs, SiGe . . . ), the aforementioned metals or oxides, nitrides and sulphides.

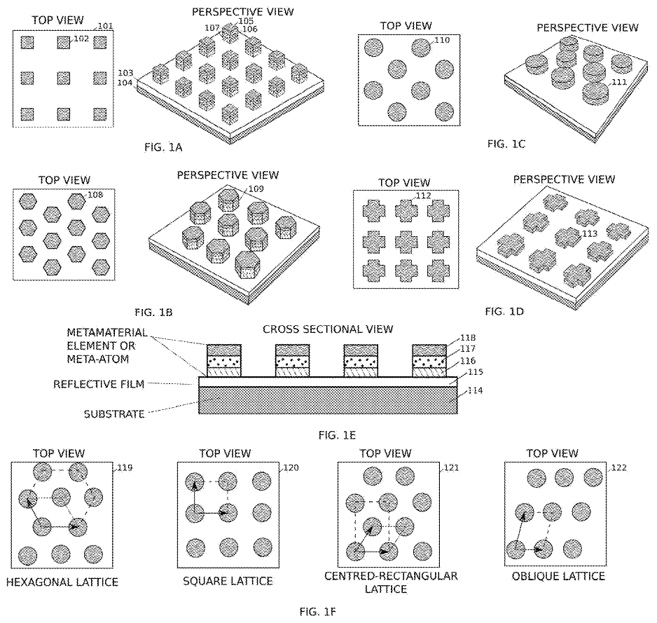

Referring now to FIGS. 1A-1F, various example embodiments of a catalytic metasurface (101) are shown. The example catalytic metasurface firstly includes of a metallic or dielectric substrate greater than 1 μm thickness (104) to enable mechanical stiffness and robustness. A metallic or semiconductor reflective film (103) (e.g. having a reflectivity of at least 50%) overlays the substrate. In some non-limiting example embodiments, the thickness of this layer can range, for example, from 1 nm to 500 nm thickness in order to reflect a wide range of wavelengths. The metallic or semiconductor reflective film can be formed from metallic elements and alloys, or from semiconductor elements or semiconductor alloys, for example, such as Al, Ag, Au, Sn, Fe, Cu, Ni, stainless steel, Si, Ge and their combinations thereof.

The reflective film is provided to enable the effective index of the entire metamaterial surface comprising the periodic arrangements of metamaterial elements to achieve impedance matching with surrounding index. In stark contrast, previous implementations that employ a dielectric spacer are meant for separating the electric field of the plasmonic structures/layers away from other layers or the substrate. The arrangement of the metamaterial elements may be periodic or semi-periodic (locally periodic, such as, over 1 to 5, 1 to 10, or 1 to 20 unit cells, but having periodicity that diminishes over many unit cells, such as over 5, 10, 15 or 20). The present metamaterial elements can be contrasted with plasmonics, which involve randomized arrangements of different shapes and sizes.

The metamaterial elements (102) can include, for example, 1 to 3, or more, different stacked layers, with at least two layers being formed from different materials, and the thickness of the metamaterial elements can range, for example, from 50 nm to 500 nm. The number of layers can be further modified, such, as for example, increasing the number of layers, such as to, or beyond, 10 layers.

If the metamaterial element is formed from one material (105), then that material is the primary catalytic material. Examples of such materials include Al, Si, Ti, V, Cr, Fe, Co, Ni, Cu, Zn, Mo, Rh, Pd, Ag, Sn, W, Ir, Pt, Au in either elemental, sulphide, oxidized, or nitride forms or mixtures/alloys of such forms in a composite material, or metal alloys such as Co—Pt, W—Cu, Ni—Fe, Al—Ni, Ni—Si, Ga—Pd, Pd—Ag, Pt—Ru, Au—In, Fe—Co, W—Ni—Pt, Pt—Sn—Ru, Pt—Sn—Ni, Fe—Cu—Al, Cu—Mn—Co, Cu—Ga—Zn, Ag—In—Zn and others. If the metamaterial element includes more than one layer (106), each layer can perform a function that can enhance the catalysis reaction. In one example, nickel and an adjacent metal oxide can be used to convert CO₂+H₂ to CO and CH₄. The metal oxide absorbs CO₂ and nickel absorbs H₂. The absorbed CO₂ that migrates towards the nickel by thermal diffusion experiences a chemical energy difference on the nickel that causes the CO₂ to dissociate (break apart) when it comes into further contact with absorbed hydrogen on the nickel. The metal oxide is the molecule absorber and helps to chemically activate the molecule but the actual reaction takes place on the metal. In another example, copper and Zinc oxide are used to convert CO₂+H₂ to CH₃OH methanol.

Combinations of various primary catalysts and co-catalyst materials are included to enhance the reaction rate of the primary catalytic material. Examples of such material combination include Ruthenium/Aluminum oxide, Ruthenium/Silicon oxide, Ceria/Aluminum oxide, Gold or Platinum/Zn₂GeO₄, Tantalum/Titanium oxide, Platinum/Titanium Oxide, Palladium/Titanium Oxide, Titanium/Copper Oxide, Platinum/Cadmium Sulfide or Platinum/Bismuth Sulfide, Zinc-Titanium/Silicon oxide, Chromium-Titanium/Silicon Oxide, Titanium/Tin Oxide and others. As described in further detail below, metamaterial elements can be formed according to a number of fabrication methods. For example, photo-lithography, either with a shadow mask or without a mask, which then involves using a laser or electron beam exposure onto a photoresist. After writing the pattern, we deposit the aforementioned materials using evaporation, sputtering, or atomic layer deposition.

The metamaterial element structures are configured to have spatial dimensions that are smaller than a wavelength range of interest. Furthermore, a metamaterial element and underlying film may be formed from different metals or materials, such that there is a difference in refractive index. For example, in the copper metamaterial examples described herein, the copper metamaterial elements (cubes) are 100 nm to 150 nm height and width, which is smaller than the 300 nm to 700 nm wavelength of interest. Furthermore, the copper metamaterial elements reside on a gold film, as opposed to a copper film, such that a material difference exists and the structure is not a single film.

The subwavelength concept employed herein is beneficial because the electromagnetic theory is transformed from 3D to 2D, with different physics description. In 2D, the light waves hitting the periodic unit cell will become inhomogeneous not homogenous, and can experience optical scattering laterally along the plane of metasurface. The components of the refractive index or dielectric constant along x, y, z will have different values and dispersion, which allows for standing electric field waves laterally across the surface, while on the z direction the cubes are not thick enough to be ‘visible’ to the incident light (also good for non-zero incident angles). The presence of the electric field discontinuities laterally along the surface can be thought of as a surface electric current that disrupts any reflectivity arising from the material intrinsic optical properties and thus the suppression of reflectivity from the underlying film and metasurface elements leads to near-perfect absorption.

The metamaterial elements may include one or more layers. In embodiments that employ a plurality of layers, at least two of the multiple layers may be employed to for different functions, such as catalytic or electron/hole transport functions. For example, in implementations that include metamaterial elements having at least three layers, or more layers, which include one or more semiconductor layers, several functionalities may be fulfilled.

In one example implementation, three layers of the multilayer structure can represent a sequence of a p-type hole donating semiconductor material, an intrinsic semiconductor material, and an n-type electron donating semiconductor material. Due to the design, geometry, and periodicities of the metasurface, the p-i-n semiconductor junction as the metamaterial element will can exhibit near-perfect optical absorption over a wide range of incident angles and wavelengths, facilitating increased or optimized photo-current generation for charge injection into reactant molecules. The p-type layer will experience a large concentration of holes and the n-type layer will experience a large concentration of electrons. Electrons can be transferred to a reactant molecule to enable reduction and holes transferred to enable oxidation reactions. The catalytic reaction/s can proceed at a lower activation energy.

Examples of materials for forming the p-i-n junction include, but are not limited to silicon, germanium, gallium arsenide, germanium telluride, and beyond with example doped elements of boron, nitrogen, phosphorous amongst others. Either one, more or all material layers can perform catalysis.

FIG. 1B, 1C, 1D are variations of the cubical metasurface of FIG. 1A, with hexagonal (108) (109) and cylindrical (110) (111) and cross-like element (112) (113). The optical meta-atoms or metamaterial elements can include one or more layers or one or more geometry with functions as described in the embodiment of FIG. 1A.

FIG. 1E shows the cross section of a typical catalytic metasurface. The substrate as described earlier enables a relatively flat plane (114). The reflective film which can consist of metals, alloys of metals. In some example embodiments, the reflective film can be a semiconductor. As described above, the reflective film is in direct contact with the array of metamaterial elements, which in turn can include various layers (116, 117, 118). In some example embodiments, the lowest layer of a multilayer metamaterial element (that is, the layer directly contacting the underlying reflective layer) may be a dielectric layer.

Because the periodicities (or semi-periodicities), geometries and sizes of metamaterial elements are additional parameters that can be varied in order to enable, achieve or optimize an engineered effective refractive index of the surface layer, the lattice configuration can be selected to enable such tuning. Several basic Bravais lattice configurations are suitable for metasurfaces, such as hexagonal (119), square (120), centered rectangular (121) and oblique (122) lattices which could affect the polarization independency. Further, the areal density of the meta-atoms vis-à-vis the properties of the suitable engineered effective refractive index of the surface layer can be designed to facilitate, enhance or optimize for catalytic chemical reactivity.

In the disclosure the International Patent Publication No. WO2014169258A1, titled “Photocatalytic Metamaterial Based on Plasmonic Near Perfect Optical Absorbers”, a planar device is described for photocatalysis. The surface of the device comprises either a nanocomposite of various plasmonic metal nanoparticles embedded in matrix, or a patterned metal layer. A transparent spacer layer underlies the top layer, followed by a metallic reflective layer. The mechanism for achieving perfect absorption and plasmonic effects is via plasmonic interaction between the nanocomposite or metal patterned layer, with the reflective metal film. The role of the intermediate spacer layer is to enable small gap separation between the two metallic structures and assist generation of localized plasmonic associated electric fields within the top layer to couple with similar electric fields generated by the reflective layer.

There are key differences between the disclosure and teachings of International Patent Publication No. WO2014169258A1 and the present disclosure. The differences are due to the different physical mechanisms for achieving perfect absorption and photocatalytic enhancements. The first difference is the omission of the dielectric spacer layer.

The second difference is that the role of the periodicity, geometry and sizes of the metamaterial elements, as described in this disclosure, is to enable refractive index engineering of the top layer, such that an effective refractive index encompassing the metamaterial results in minimal refractive index contrast with the surrounding medium. With minimal index contrast, impedance matching between the surrounding medium and the metamaterial is achieved, resulting in broad band near-unity optical absorption.

Accordingly, various example embodiments of the present disclose employ catalytic materials as metamaterials structures for the use of photo and/or thermal catalysis. The catalytic materials have both optical and catalytic properties that are configured, via optical engineering, to improve or drive the catalysis.

The presence of the reflective layer directly underlying the array of metasurface elements increases the optical path length within the effective index layer such that optical absorption can be improved.

In addition, in some example embodiments, electrical connection between the metamaterial elements through the connection of the underlying metallic reflective layer allows propagation of SPPs (surface plasmon polaritons) and coupling between adjacent metaatoms.

Furthermore, the plasmonic interactions that arise in a metamaterial are associated with localized plasmonic resonances at the corners and edges of the geometry of the metasurface element. Due to the impedance matching, plasmonic coupling between metasurface elements are substantially enhanced and can occur over a larger spacing between these elements than that typically achieved without impedance matching. Also, the impedance matching can be extended to semiconductor-based design for generation of electron-hole pairs with small scattering losses which is not conceived in prior art.

The omission of the spacer layer can also serve a photocatalytic purpose. Typical transparent dielectrics are poor electrical and thermal conductors, which can result in poor electrical transport between the metamaterial elements or to the substrate, or an undesirable thermal gradient between the metamaterial elements and substrate.

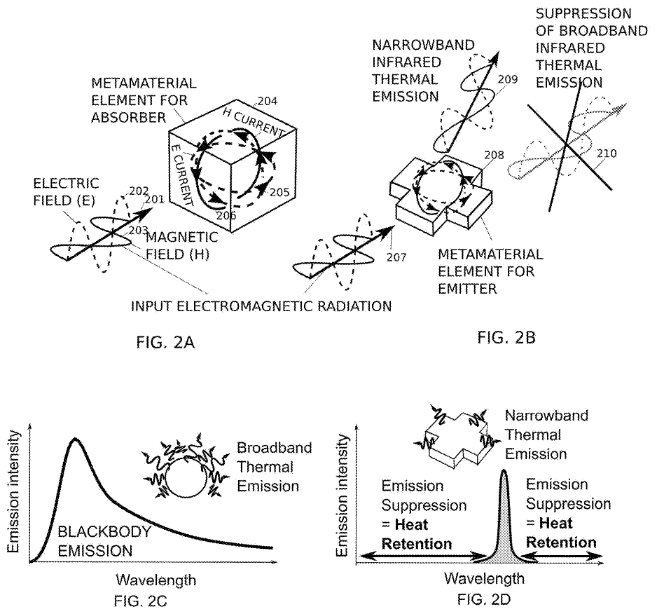

FIGS. 2A-2D illustrate an incident orthogonally-propagating electromagnetic (201) (202) radiation (203, 207) impinging onto an individual metamaterial element. While the example metamaterial element 204 is shown in in cubical geometry, it is to be understood that the geometry of the metamaterial element can take on a wide variety of shapes.

Within a meta-atom suitable for achieving broadband optical absorption (FIG. 2A), the electromagnetic resonant response consists of looping electrical and magnetic field currents that reinforce each other. The electromagnetic response is strong for the wavelength range for which the metasurface is designed and/or optimized.

In the case of a metamaterial element suitable for infrared emission (208) (FIG. 2B), the temperature of the meta-atom induced by the electromagnetic response generates infrared emission, which is modulated by the geometry of the emitter to emit in a specific band (209). Electromagnetic emissions in the undesired infrared wavelengths are suppressed (210). This suppression results in a higher temperature of the catalyst structure due to increased retention of trapped heat. It will be understood that the cross-like shape is merely provided as an illustrative example, and that other shapes can be employed in the alternative in order to achieve a desired thermal emitter metamaterial. The cross-like shape serves only as an illustrative example. As a further illustration of the property of the metamaterial emitter, the emission spectrum of a blackbody is compared against the narrow band emission of the metamaterial. In a conventional catalyst that has good absorption of electromagnetic radiation, its emission profile is broad and spans the near to mid-infrared radiation (FIG. 2C).

In the metamaterial element of FIG. 2B its thermal emission under absorption of electromagnetic radiation is narrowband (FIG. 2D), while the suppression of thermal emission of the remaining range of the infrared spectrum reduces radiative losses, which will trap and retain heat. Without intending to be limited by theory, it is noted that the emission spectrum is essentially the absorption spectrum, according to Kirchoff's law. The difference, however, is that in the infrared wavelength range, the emission is heat. Accordingly, incoming heat at that wavelength gets absorbed, while if the metamaterial gets heated up by a heat source (e.g. a hot-plate), it will generate radiative heat at that specific wavelength of absorption/emission, thereby modifying the emission spectrum relative to what can be produced by a blackbody, and enabling the heat radiation to be spectrally focused on molecular vibrations based on their chemical bonds.

FIGS. 3A and 3B illustrate a catalysis process of a catalytic metamaterial in a gas phase photo-reactor (301). FIG. 3A shows a metasurface structure as described in FIG. 1 in a batch photoreactor. The metasurface is irradiated, for example, over a wide range of incident angles (for example, from normal incidence to 45, 50, 55, 60, or 65 degrees), for example, by broadband ultraviolet (302), visible (303) and infrared (304) wavelength photo-illumination via a lamp, optical fiber, or solar illumination. The wavelengths of the illumination can range from 300 nm to 5 μm, and the band of absorption by the metasurface can be designed to lie within a subrange, such as, for example, from 300 nm to 1.5 μm wavelength. In another example, an NIR metamaterial may be designed to have an absorption spectrum with between, for example, 1 to 3 μm, a visible light metamaterial may be designed to facilitate absorption between 300-700 nm (e.g. as exemplified by the copper metamaterial examples described herein).

The metasurface undergoes the photo-illumination intensity enhancement in order to enable the desired photo-thermal temperature rise and/or photo-generation of charge carriers. The metasurface can absorb, with near-perfect absorption (as defined above), the desired wavelengths at low (315) 70° angle to normal 0° angle (314) of incidence illumination. The metasurface can also be heated by a heating element (308) up to a set temperature to further increase the rate of reaction. Correspondingly, reactant molecules or precursors in gas or liquid form are fed into the reactor (312) as a pass-through flow reactor (309), FIG. 3B. The array of metamaterial elements (311) absorbs the light through the window (310) to be heated, or generate photo-carriers, or a combination thereof, in order to convert reactant molecules to product molecules. The resulting catalytic products are removed out of the reactor or recycled in a closed loop to increase efficiencies (313).

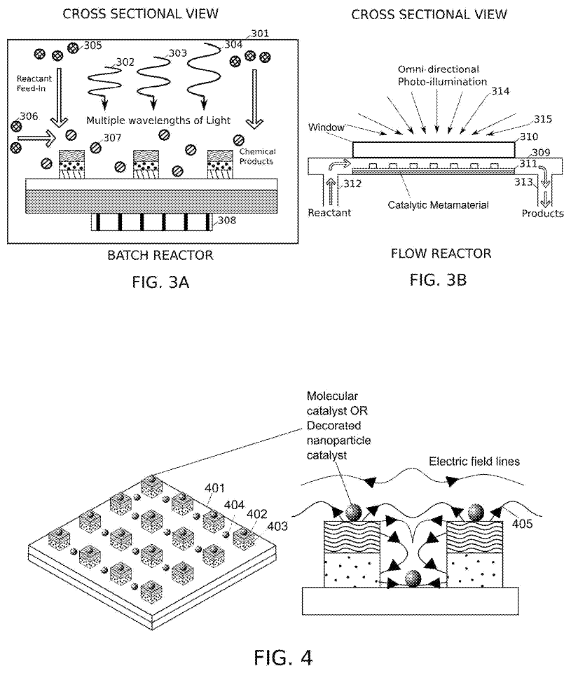

In FIG. 4, an example metasurface (401) is presented with the introduction of molecular catalysts or small nanoparticles decorating the surface (402) of the metamaterial element (403) and in the spaces between them (404) (decorating the surface of the metamaterial element with very small particles, so the decorating particles do not form a multilayer or coating, but a structure with additional adhered material).

The metamaterial element, because they are sub-wavelength in size, will have an effective refractive index as discussed above. According, it is not the metamaterial element helping an adjacent catalytic material but the catalytic material or material layers that act as one, so as to act as a metamaterial element.

In other example embodiments, organometallic compounds and 2-dimensional materials may be provided as an atomic coating on the metamaterial element. Examples of organometallic compounds include porphyrins, phlthalocyanines, polypyridines and bi-metallic complexes that can be coated on the metamaterial structures as a chemical surface functionalization to assist in the catalytic reaction. Examples of 2-dimensional materials include graphene, boron nitride, graphene nitride, transition metal dichalcogenides, xenes and phosphorene, which can be coated as flakes decorating the elements or cover the element.

The metamaterial elements are made up of catalytic materials that can also be adjacent to materials associated with enhancing catalysis such as for example, a semiconductor that generates photo-charges. The semiconductor may not directly be driving the catalysis reaction but contributes charges to drive it.

A given metamaterial element can include one or two layers where two different material Is are used. If two layers are used, the top layer (402) may include a metal and the bottom layer (403) may include a metal or semiconductor material. If one layer is used, it includes a metal. The molecular catalyst include but are not limited to complexes such as Fe, Ni and Co aza macrocyclic and polypyridine complexes, Ru complexes such as (Ru₄)(PW₁₀)₂, (Ru₄)(SiW₁₀)₂, [Ru(bpy)₂(H₂O)₂]²⁺(bpy=2,2′-bipyridine), Co complexes such as Co₄(PW₉)₂, Mn complexes such as [Mn-terpy(H₂O)O]₂(NO₃)₃, Ir complexes such as [Cp*Ir(bpy)OH]BF₄, among others.

In the cross section of the metasurface, the geometry and periodicities of the metasurface are selected (e.g. designed, controlled, configured, optimized) such that strong electric fields (405) (e.g. electrical field generated between the constructs that are amplified from the incident photo-intensity by at least a factor of 2) are generated between the constructs, amplified by impedance matching. The electric fields strongly polarize the molecular catalysts, which may enhance its kinetic catalytic rate, or lower its overpotential.

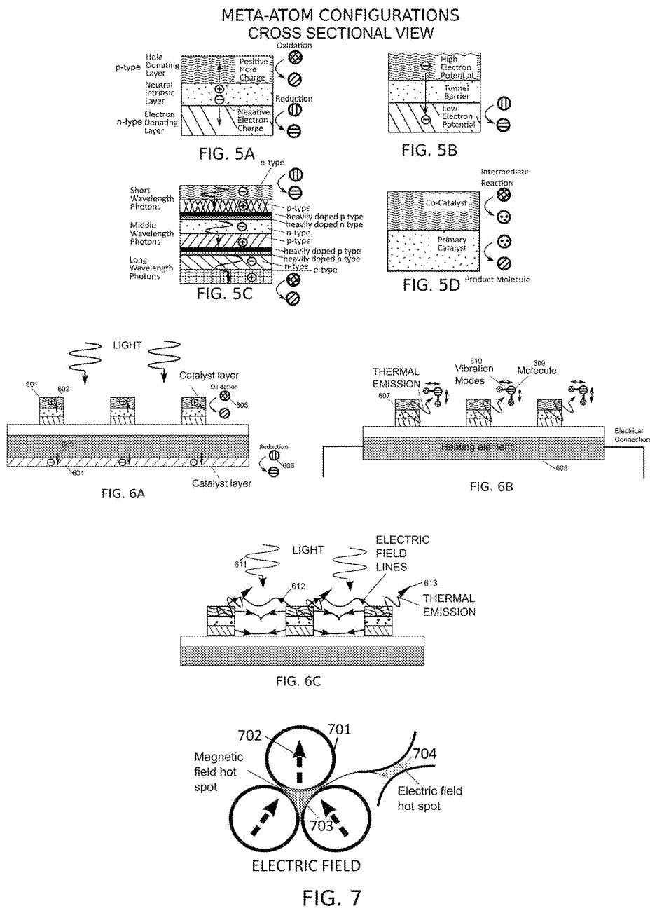

FIGS. 5A-5D shows various example material layered designs for each individual metamaterial element on a metasurface, that are configured for various aspects in catalysis reactions. FIG. 5A shows an example 3-layer design of a p-i-n type semiconductor junction. Upon photo-absorption under the aforementioned wide band and wide angular photo-illumination, electron and hole charge carriers are generated within the intrinsic layer which diffuse through the interface junctions towards the n-type and p-type layers, respectively. The charge separation beneficial to prevent charge recombination. The electron and hole charges can continue to diffuse towards the surfaces since the layers are nanometer to micrometer thick, which can react with reactant molecules as reduction and oxidation reactions. One example reaction is water splitting, where water is reduced to oxygen at the anode and H₂ is oxidized to water at the cathode.

FIG. 5B shows another charge separation scheme known as a tunnel junction, where a layer with a high energy conduction band edge tunnels a photo-excited electron through the barrier layer into the layer with a low energy conduction band. The energetics of the low energy band would be favorable for catalytic reactions while receiving excess electrons for driving its kinetics. The optical absorption spectrum is associated with the entire metamaterial element, but in this case it is possible to associate each layer of the element to one band of the absorbed spectrum. In this configuration, the top layer is a semiconductor with a larger band gap than the bottom layer so that the electron potential in that layer is higher. The top layer has a higher refractive index than the bottom layer, but because of metamaterial structuring the effective index of the top layer is decreased, which leads to higher absorption in that top layer due to less refractive index contrast between the layer and the surrounding environment.

It should be noted that other charge separation schemes are possible, such as the direct/indirect Z-scheme, S-scheme, Type I straddling gap, Type II staggered gap, Type III broken gap heterojunctions and others. In a Z-scheme, the holes and electrons at each interface recombine, which enable excess holes on the surface of the topmost layer, and excess electrons adjacent to the metallic film.

FIG. 5C shows a tandem cell like configuration where various layers have band gaps that are suitable for absorbing a band of wavelengths ranging from 100 nm to 5000 nm. With several layers it is possible to absorb a broadband spectrum, such as, for example, from 500 nm to 2000 nm, such that visible and infrared wavelength regimes are absorbed. For example, a perovskite and silicon tandem cell can absorb light of wavelengths less than 800 nm and more than 800 nm respectively. Another example of tandem device that has been used for water splitting is p-GaAs/n-GaAs/p-GaInP2. The GaInP2 layer has band gap of 1.8 eV that absorbs light below 700 nm, and the GaAs layers have band gap of 1.4 eV which absorbs light below 885 nm (O. Khaselev, J. A. Turner, “A Monolithic Photovoltaic-Photoelectrochemical Device for Hydrogen via Water Splitting”, Science, 280, 1998). Several heavily doped p and heavily doped n type junctions interface each p-n junction, in order to form tunnel junctions. The heavily doped layers range from a thickness of 3 nm to 20 nm. In this manner, the photo generated potential within the metamaterial element can be enhanced, increased, and/or optimized/maximized.

FIG. 5D shows an example bi-layer implementation that includes a co-catalyst layer and a primary catalyst layer, with the dual layer structure enabling a more favorable energetic pathway to convert a reactant to product of interest. The reactant molecule may be initially activated on the co-catalyst, which subsequently converts it into intermediate species which can diffuse on its surface towards the primary catalyst. One example is water splitting on Pt/TiO₂ where Pt serves as the H₂ reduction site, and H species migration on the surface towards Rutile TiO₂.

To further illustrate on how charge carrier separation may be feasible on a metasurface, FIG. 6A shows how reduction and oxidation reactions can occur over a wireless metasurface cell where both half cells are on opposite sides of the substrate. Light incident on one side of the metasurface generates electron-hole pairs as described in FIG. 5A, which are separated at the junctions (601). Holes can travel to the top layer of the metamaterial element (602) such that oxidation reaction takes place (605). Because, in the present example embodiment, both the substrate and reflective layers are metallic, it is possible for electrons to migrate towards the back side of the metasurface support (603), such that an adjacent catalytic layer (604) can receive electrons. In all, an oxidation reaction can occur on the top surface (605), while a reduction reaction can then occur on the back side of the metamaterial support (606). Such an example implementation may be particularly beneficial for the production of H₂ and O₂ in separate and isolated environments to achieve the required safety measures.

FIG. 6B further illustrates the utility of a metasurface (607) configured or optimized for thermal emission. Resistive heating is achieved through electric connection of the metallic reflective layer with a heating element substrate (608) or/and photothermal effect through incident light illumination delivers electromagnetic radiation to the metasurface, in order to raise the metasurface temperature. Because of the electromagnetic resonances occurring within each metamaterial element, its thermal emission is very high approaching 80% to 100%. The geometry, size and material of the metamaterial element results in narrowband thermal emission, within one or more emission bands of 50 to 300 nm within the infrared spectrum (e.g. residing within the 1 μm to 10 μm wavelength range). The thermal emission can be engineered to match one or more vibrational modes (610) of molecules (609), such that the molecule can be directly excited, analogous in concept to microwave heating of food through resonant coupling to molecular vibrational modes within the food. For example, one of the vibrational modes of H₂O can be excited by wavelengths of 3506 cm⁻¹ or 2852 nm, and for CO₂ is 2565 cm⁻¹ or 3898 nm. By exciting molecules in the vicinity or those chemisorbed onto the surface of the metamaterial element, it is possible to substantially enhance catalytic reactions and their selectivity.

FIG. 6C is an illustration of a metamaterial structure that possesses plasmonic response in the IR region designed to enhance the localized field intensity in the specific band so as to excite the vibrational modes of reactant molecules and destabilize the specific bonds in the reactant species through exposure to high localized field intensities, resulting in higher reaction rate, better selectivity, and reduced reverse reaction rates. Under photo-illumination (611), strong electric fields (612) coupled between the metamaterial elements enhances the strength of the electromagnetic emission, which is narrowband (613) due to the geometry of the metamaterial structure as discussed above.

The example design has periodicities of length scales on the order of infrared light, namely 2 to 10 μm. The structures are also 1 to 8 μm in widths. Due to the periodicity, metals that have plasmonic response in the infrared will experience constructive/destructive interference across the surface-which generates the resonance. In addition, within the metamaterial structure it is a periodic multilayer of metals and semiconductors which also generates internal interference to generate plasmonic resonance.

### Colloidal Catalytic Metamaterial

As mentioned above, metamaterials generally requires sub-wavelength length components and at least semi-periodicity. Thus sub-wavelength scale particles suspended in a liquid, that have a regular spacing between them, can achieve unique optical properties similar to that of a meta-surface. Colloids, where milk is a well known example since it is a suspension of fat droplets within water, are suitable for such an arrangement.

The particles do not necessarily have to be suspended with a large gap larger than the size of the particles. If a cluster of particles can achieve a regular arrangement within that cluster with a small fixed gap between the particles, that cluster can be considered as a metamaterial element. Each cluster of particles in the colloid should be similar, so that all the clusters can be regarded as a metamaterial colloid as a whole. The nanoparticles that form a given colloidal catalytic metamaterial cluster element may have diameters that are less than a desired minimum operating free-space wavelength of incident radiation, such as, for example, between 25 nm to 100 nm, or, for example, from 25 to 500 nm.

At least one of the nanoparticles that forms a given colloidal catalytic metamaterial cluster element is a catalytic material. In some example embodiments, each nanoparticle that forms a given colloidal catalytic metamaterial cluster element is a catalytic material. The colloidal catalytic metamaterial cluster elements, which include catalytic materials, can drive catalytic reactions. The catalytic materials can include but are not limited to Al, Si, Ti, V, Cr, Fe, Co, Ni, Cu, Zn, Mo, Rh, Pd, Ag, Sn, W, Ir, Pt, Au in either elemental, sulphide, oxidized or nitride forms or mixtures of such forms in a composite material, or metal alloys such as Co—Pt, W—Cu, Ni—Fe, Al—Ni, Ni—Si, Ga—Pd, Pd—Ag, Pt—Ru, Au—In, Fe—Co, W—Ni—Pt, Pt—Sn—Ru, Pt—Sn—Ni, Fe—Cu—Al, Cu—Mn—Co, Cu—Ga—Zn, Ag—In—Zn and others.

The colloidal catalytic metamaterial is formed from a colloidal suspension of colloidal catalytic metamaterial cluster elements, with each cluster element being formed from a plurality of particles. FIG. 7 shows an example of a metamaterial cluster element that is formed from three nanoparticles.

FIG. 7 shows a non-limiting example of a colloidal catalytic metamaterial cluster element formed by three nanoparticles. In other example implementations, 3 to 1000 of nanoparticles in a cluster such that the cluster has internal periodicity due to the regular gaps between the particles-like a nanocrystal-except that the crystal is made up of solid particles and not ion or atoms.

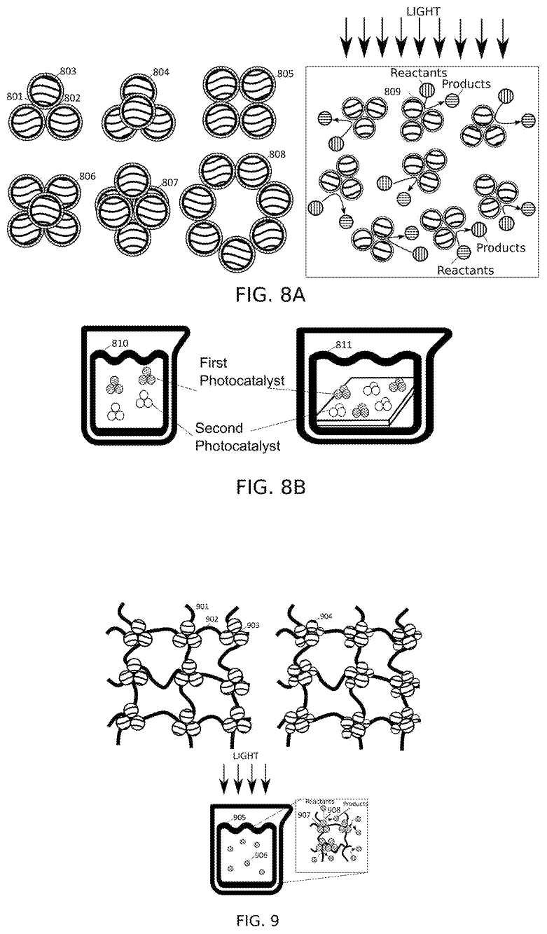

FIGS. 8A and 8B show some non-limiting different example arrangement of clusters comprising particles. The cluster elements (801) can include metals and/or semiconductors that can also perform catalysis reactions.

In order to generate electrical resonance, a small nanoscale gap, such as, for example, of 1-100 nm, or for example, 1-500 nm, between the elements of the cluster is introduced to achieve the high capacitance effect (802).

In order to achieve mechanical integrity between the particles in a given colloidal catalytic metamaterial cluster element, as well as enable consistent and mechanically stable separation between particles, colloidal self-assembly techniques may be used to hold the particles together (803) while maintaining the aforementioned gap. Non-limiting examples of such methods include DNA, protein assembly, ligand attachment, polar-polar surfactant attachments, non-polar to non-polar attachment by van der Waal's forces. Preferred assembly media include the use of surfactant and block copolymer liquid crystals, wormlike micelles, and microemulsions.

Generally in a liquid medium, a large particle that is surrounded by smaller particles can achieve a ‘halo’ of smaller particles. The halo induces a repulsive barrier that prevents a large particle from easily approaching another large particle with a similar halo. However, if two large particles without halos are close enough, the particles experience an osmotic pressure, which is a type of capillary pressure from the small amount of liquid within the gap of the particles—the particles thus stick together naturally. Thus two large particles each with halos of smaller particles that are close to each other, in the same order of distance as the size of the large particles, will experience both repulsive and attractive forces, which will maintain a consistent gap between the particles.

For example, in fat emulsions (butter and milk), the fat globules (large particles) are stabilized by the presence of lipids (small particles) (long hydrocarbon chain with a fat-favoring head and a water-favoring end). With an appropriate amount of lipids to get between the fat droplets (which is the concentration of the lipids) so that the fat droplets maintain the same size and gaps throughout the emulsion. Concentration of smaller particles is thus beneficial. Too little concentration and the particles will agglomerate randomly. Too much concentration the large particles will sediment, i.e. will not be suspended and fall to the bottom of the liquid container.

One can also create stronger repulsive forces by using electrostatic charged smaller particles on the large particles.

In some example colloidal metamaterials of the present disclosure, the cluster of particles are held together by the attractive forces of the particles and repelled by the presence of a layer of micelles on the particles, and presence of micelles within the liquid such that the clusters are experiencing an optimal attraction/repulsion within the cluster, and a general amount of repulsion between the cluster to cluster.

In the absence of magnetic materials and in order to generate a magnetic response, the arrangement of the cluster elements must enable looping of electrical currents thereby giving rise to magnetic dipoles under the excitation of photonic radiation. Most catalytic materials do not have a strong magnetic response, thus to generate the EM field, the arrangement of the cluster is necessary to generate an ‘effective’ magnetic permeability as another optical parameter to tune. Control of the magnetic permeability can be useful to design the colloid cluster to achieve the optical spectrum you want.

FIG. 8A illustrates several non-limiting examples of how particles can be assembled to form a given colloidal catalytic metamaterial cluster element. As shown in the figure, the individual colloidal catalytic metamaterial cluster elements can include, for example, a triangular cluster, a triangular-based pyramidal cluster (804), a square cluster (805), a square-based pyramidal cluster (806), a diamond-like cluster (807) or a ring-like cluster (808), or other configurations.

Although the example illustrations in FIGS. 7 and 8A show the nanoparticles forming the colloidal catalytic metamaterial cluster element as spherical nanoparticles, it will be understood that other particle shapes, such as cuboids, pyramidals, cylinders, or cone-like particles, can be employed in the The built with spheres of consistent or inconsistent diameters and material composition.

As a collection of colloids, the arrangement of clusters will be randomly oriented (809). There will still be a net magnetic and electric response such that high optical absorption and low scattering is achieved. There is an electric field resonance in the gaps between the particles within the cluster, and the presence of a current loop within the cluster generates a magnetic field, thus the cluster achieves a strong electromagnetic resonance. The cluster of particles thus acts like an antenna that experiences high absorption of incident light, and the periodicity of all clusters ensures that an effective index of the entire colloid can match the surrounding environment index. This is achieved by enabling the effective refractive index of the colloidal metamaterial, that includes the volume of clusters and solution, to approach that of the index of surrounding medium (or impinging medium) through the illumination wavelength of interest. For example, water has a refractive index of 1.2 to 1.4 within the visible regime. Hence the effective index of the volume of the clusters and the water has to approach that of water.

In some example embodiments, the impedance matching is provided such that broadband absorption that can be measured. The impedance matching is a physical mechanism (based on physics) to get that good absorption. To achieve impedance matching the effective index of the colloid or metamaterial has to be engineered, and the way to engineer that is through periodicities, sub-wavelength scales and in the case of colloids, arranging the nanoparticles into regular clusters. The second test is whether the metamaterial comprise catalytic materials and whether it is engineered with optical properties to enhance or drive the catalytic reaction that the materials are associated with.

The optical absorption band of the colloidal metamaterials can span>100 nm with a 70% to 99% absorption residing within the wavelength range of 300 nm to 5.0 μm In a suspension under photo-illumination, the catalytic metamaterial clusters achieve the aforementioned electrical resonance hot spots that will enhance the catalysis reaction rate or thermodynamics.

FIG. 7 also shows the generation of electrical and magnetic resonances when a colloidal metamaterial cluster element under electromagnetic radiation (701). The electric and magneto-electric dipoles induced in the cluster give rise to the induced electric and magnetic properties of the entire colloidal metamaterial system, resulting in resonance effects, impedance matching and near-unity absorption. The resonances enable each cluster to act like antennas with an effective electric permittivity and magnetic permeability. Each cluster and the space between each cluster is considered 1 periodic unit cell. The effective refractive index of the whole colloid comes from the unit cell periodicity and both the electric permittivity and magnetic permeability of each cluster (one can assume magnetic permeability of 1 if there is no magnetic response, but in colloids cluster we can induce a magnetic field so that can help tune the effective index). With that effective refractive index similar to that of water, it enables impedance matching and thus broadband absorption.

Due to the generation of the electric dipoles (702) within each nanoparticle, a magnetic field is created within the cluster (703). Concurrently, the electric field set up within the cluster of particles enables a strong electric field to exist within a small gap between the particles (704), in the same manner as an electrical capacitor. The electrical and magnetic resonances within the cluster enable near-unity optical absorption at wide incident angles of light and wide wavelength range.

The geometry, structure of individual colloidal metamaterial clusters, as well as the overall volume fraction of the clusters within the liquid medium, is highly sensitive to incident radiation and hence the properties of the metamaterial are highly tunable. In addition, the coherence of electric and magnetic field resonances enhances the electric field in between the nanoparticles, which can assist catalysis.

In FIG. 8B, two different sets of metamaterial clusters are presented to drive several reactions, such as reduction and oxidation reactions. They can include different sets of materials or different cluster arrangements that allows absorption of different wavelengths of light. They can be suspended in solution (810) or dispersed on a substrate within the solution (811).

To improve the metamaterial effects of these clusters of particles, it is possible to arrange and affix them within a semi-permeable membrane such that there is a relatively consistent periodicity (e.g. semi-periodicity, as noted above) and spacing between these clusters, as shown in FIG. 9. The presence of ligands and other surfactants to bind the particles are minimized. Long chains of polymers (901) are cross-linked with other chain of polymers (902) in a square, cubic, hexagonal, pentagonal, octagonal, and other arrangements in two dimensional sheets or three-dimensional lattice. The polymer crosslinks and network will fix the cluster of particles to achieve similar arrangements and periodicities while each cluster maintains its electrical and magnetic resonances.

In another example embodiment, each cluster consists of a set of a disordered arrangement of spherical particles with varied diameters (904), such that a strong magnetic and strong electric response is generated under light. While the metamaterial effect is weaker than that of the aforementioned regular set of particles, it has lower scattering and higher absorption than a single particle due to the approximately periodic arrangement of the clusters. The disordered clusters are fixed to the polymer or assembly cross-links and are relatively periodically arranged (semi-periodicity), such that an overall effective refractive index of the volume of the cluster-polymer network approaches that of the surrounding medium (i.e. in the same manner as the previously described metasurface, each cluster and surrounding space is considered as one unit cell, and the periodicity between unit cells leads to an effective index of the colloid). Impedance matching is possible within the colloidal system which significantly reduces the scattering coefficient, which will further improve the catalytic efficiencies of colloidal slurry reactors. For example, the clusters and the periodic spacing between the clusters forms periodic unit cells (in 3D), the clusters, due to their cluster arrangement achieve electric and magnetic resonances (or dipoles if that's easier to understand) that creates effective permittivity and permeability. These and the unit cell periodicity results in an effective index that ideally matches that the of the surrounding medium-thus impedance matching.

The colloidal catalytic metamaterials described in the present disclosure shown by FIG. 9 may be configured to carry out catalytic reaction of interest with enhanced rates under photo-illumination of a range of wavelengths, for example, from 300 nm to 5000 nm, and over a wide range of incident angles, such as, for example, 0 to 45 degrees. It has been shown that a 2-dimensional monolayer of ~80 nm gold nanoparticles with gaps of 2 nm can have an unnaturally high effective index of 6.4 in the near-infrared. Conversely, both an ~20 nm Au and AuAg alloy nanoparticle ensemble fixed in place by a polymer film, to have a periodic gap of 5 nm, have shown a low effective index of 1.1-1.5 at the 400-550 nm wavelength range (J.-H. Huh, J. Lee, S. Lee, Soft plasmonic assemblies exhibiting unnaturally high refractive index, Nano Lett. 2020, 20, 4768; Kim, J., Kim, H., Kim, B. et al. Highly tunable refractive index visible-light metasurface from block copolymer self-assembly. Nat Commun 7, 12911 (2016)).

As an example, a beaker containing the colloidal solution (905) in liquid, aqueous, non-aqueous, or ionic-liquid media contains reactant molecules (906). The colloidal solution contains the aforementioned polymer network and fixed arrangement of metamaterial clusters (907). The photo-excited metamaterial enables a catalytic reaction to occur from reactants to products (908) and with high freedom of fluid flow within the polymer network. The product molecules can be removed from the beaker reactor, or it can be trapped by the polymer network through the presence of active sites.

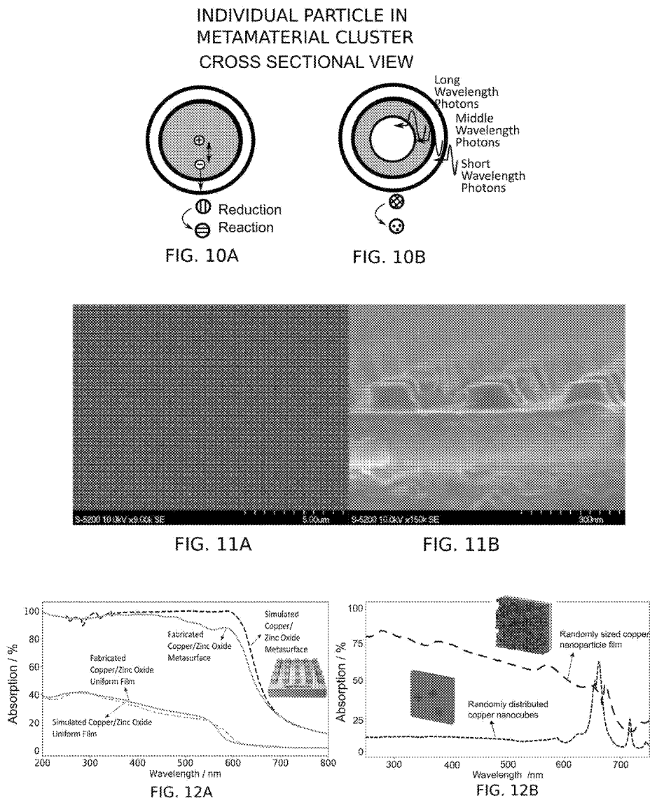

In some example implementations, one or more of the nanoparticles forming a given colloidal catalytic metamaterial cluster element may be provided as a core-shell nanoparticle. Various example core-shell material layer configurations for each metamaterial cluster element are illustrated in FIGS. 10A and 10B.

In the example implementation shown in FIG. 10A, the core is photoexcited by the strong resonances as illustrated in FIG. 7, resulting in electron hole pair separation. The core and shell comprise semiconductors and their compounds. In this design, the absorption happens mostly inside the core generating electron-hole pairs, and the charge separation into separate electrons and holes happens in the vicinity of the interface. The nanoparticle inside the cluster of nanoparticle has a thin outer layer of a different material but of thickness much smaller (more than 10× smaller) than the incident light wavelength, so that it is optically ‘invisible’ to the incoming light. Thus the light is mostly absorbed by the core of the nanoparticle. With a lower electron potential energy of the thin shell (1-20 nm thickness), electrons can accumulate at the shell to drive reduction-based reactions.

FIG. 10B illustrates an example three-layer core-shell configuration in which each layer has a band gap suitable for absorbing a different wavelengths in a similar manner as that described by the metasurface element in FIG. 5C. The various configurations shown here are not limited to the above examples. Various thermal, optical, surface catalytic reactivity and electronic functionalities can be achieved with other core-shell configurations not illustrated here. In a core shell of 2 different materials, the different band gaps and Fermi levels will cause band bending near the interface. Electron hole pairs generated at the core will be separated at the interface by the band bending such that electrons can be transported through the shell to chemically reduce a reactant molecule, and holes and be transported on the other side of the shell to oxidize another reactant molecule. CdTe—CdS, CdSe—ZnS, CdS—TiO2, FeS—ZnO core—shell, Au—TiO2, ZnO—TiO2, Fe2O3-TiO2, TiO2-MoS2, WO3-TiO2, Ag—ZnO, Au—CuO2, CdS—ZnS core—shells are some examples.

In some example embodiments, one or more of the nanoparticles forming a given colloidal catalytic metamaterial cluster element is a core-shell or multimer colloidal metamaterial structure that enables the emission in a certain wavelength to excite the vibrational mode in the reactant molecules to destabilize the specific bonds in order to increase the reaction rate, enhance the selectivity and decrease the reverse reaction rates. By engineering the optical resonances in the cluster of core-shell materials, the emission/absorption spectrum in the infrared can be engineered such that minimal heat emission (low absorption) can occur over a wide infrared range, which means that the radiative heat loss is suppressed. Parts of the infrared spectrum can be engineered to have high absorption, which means high emissions of heat at that wavelength of interest, which can be engineered to match the infrared vibrational wavelength of reactant molecules. Core-shell or multimer colloidal metamaterial structures can also suppress the thermal emission in wide range wavelengths in order to trap the heat inside the catalyst and increase the localized temperature to enhance the kinetics and reaction rates.

In some example embodiments, core-shell or multimer colloidal metamaterial structures are employed that possess plasmonic high field intensity in the IR range in specific wavelength ranges can enhance the reaction by exciting the vibrational modes in the reactants and destabilize the desired bond (associated with the specific wavelength(s) of emission) to increase the reaction rate, enhance the selectivity, and inhibit the reverse reaction rate. Particle composition and sizes may be selected and/or optimized through computational simulations such that the high index of the particle material in the infrared dispersion can be further increased by effective index engineering, so that the infrared absorption is minimized. For example, Ge, ZnSe and ZnS have high refractive indices in the IR of 4, 2.4 and 2.6 respectively. However, even a low index material can be engineered to have a higher index, that can still result in significant differences in the infrared absorption spectrum. Doped semiconductors, examples such as ITO, Si, ZnO, VO₂, can also be used to induce plasmonic responses in the IR range matching the reactant's bond energy and thus destabilize the bond(s) using localized high field intensity up to 1×10¹² V/m.

### Example of a Catalytic Metasurface

In one example, the catalytic metasurface fabricated and its associated optical and catalytic performances are shown in FIGS. 11A and 11B using electron-beam lithography (e-beam lithography) and electron-beam evaporation of the catalytic material, followed by lift-off of photoresist. 1—The first step consists of evaporating 100 nm of copper and 25 nm of gold as thin films on a glass or silicon substrate. 2—A positive photoresist is spin coated on the film. 3—Electron-beam patterning is carried out by a remote controller. Many other techniques such as photolithography, shadow masking, interference lithography, nano- or micron-imprint soft lithography can be used to pattern these structures. 4—Development of the e-beam exposed areas on the photoresist removes parts of the photoresist. 5—E-beam evaporation of chromium of <4 nm as an adhesion layer, followed by slow evaporation of copper of 100 nm thickness, followed by slow evaporation of zinc oxide of 20 nm thickness. Many other techniques of deposition such as sputtering, chemical vapor deposition, plasma enhanced vapor deposition, atomic layer deposition, molecular beam epitaxial deposition, wet chemistry deposition, can be also used. FIGS. 11A and 11B shows respectively the scanning electron microscopy top view and cross-sectional view images of the deposited square lattice cubical structure, with a cubic width of 150 nm, and a gap of 150 nm.

FIG. 12A shows the simulated optical absorption spectra of a cubical 100 nm copper/20 nm zinc oxide metasurface, in comparison with deposited copper/zinc oxide film. It can be seen that the optical spectra of the metasurface is significantly more absorptive and wider band than the film. The spectra of the experimentally fabricated film and metasurface are a close match to their numerically simulated (Finite Difference Time Domain method) analogs. FIG. 12B shows the simulated optical absorption spectra of randomly distributed 150 nm size copper nanocubes over a 1 μm² surface and shows the simulated optical absorption spectra of randomly sized copper cubical nanoparticles distributed in a random fashion as a powder film. It is clear that with individual and spaced out nanocubes the plasmonic response is narrowband and absorption is limited to 640-680 nm. With varying sized particles, the absorption profile broadens but absorption is limited to an average of less than 50%. Based on these different configurations, it is clear that metamaterial surfaces are superior to films, powders or individual particles.

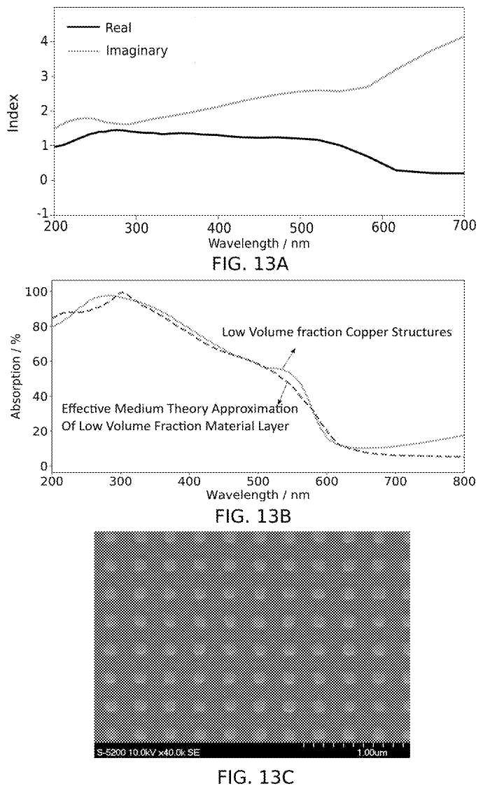

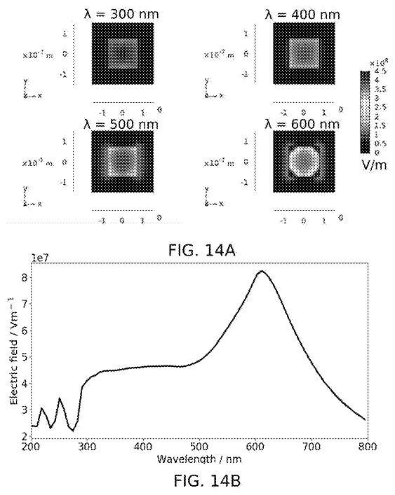

In order to analytically understand the optical properties that emerge from the metasurface, Effective Medium Theory Approximation and Plasmonic analysis were carried out. Since the zinc oxide layer has a small thickness compared to the copper block, for simplicity of calculations only the copper block is considered. FIGS. 13A-13C show that for a surface with a very low volume fraction of copper, such that the refractive index approximates a value of one within the visible wavelength range (FIG. 13A), the average absorption is much smaller than the metasurface (FIG. 13B). To show a physical example of this, the metasurface was corroded with an alkali solvent such that the shape and dimensions of the copper blocks are significantly deviated (FIG. 13C). The resulting optical spectrum matches the low refractive index derived spectrum. This shows that a simple explanation of low volume fractions of copper is not sufficient to explain the optical spectrum of the metasurface.

To amplify upon the effective medium theory approach, the general relation between the reflectivity and impedance of a material at its interface is first considered, followed by considering the volume filling fraction of a material within a virtual layer of vacuum or air and expressing the reflectivity of such a material as a function of its volume fraction.

The relation between reflectivity R and impedance Z of the medium at the interface is simply expressed as R=|(Z_{eff}−Z₀)/(Z_{eff}+Z₀)|² where the effective impedance Z_{eff} is associated with the material's electrical permittivity ε_{eff} and magnetic permeability μ_{eff} as

$${Z}_{eff} = {Z}_{0} \sqrt{\frac{{μ}_{eff}}{{ε}_{eff}}}$$

where Z₀=3772 is the vacuum constant. The effective refractive index of a low volume fraction filled surface can be approximated with the Maxwell-Garnet mixing equation, in which the volumetric ratio of the nanocubes in the top layer affect the effective refractive index of the top layer so that it matches that of the surrounding medium and reduces reflection. The effective tangential and longitudinal permittivity is thus—ε_{t,eff}=ε_{Cu}(1+p)εₐᵢᵣ+(1−p)ε_{Cu})/(1+p)ε_{Cu}+(1−p)εₐᵢᵣ), and ε_{n,eff}=Ppεₐᵢᵣ+(1−p)ε_{Cu} where the subscripts t and n represent the tangential and normal component and p is the volume fraction filling of the copper cubes within the virtual layer. The resulting effective impedance is thus

$${Z}_{eff} = {Z}_{0} \sqrt{\frac{{μ}_{eff}}{{ε}_{Cu}}} \sqrt{\frac{( ( 1 + p ) {ε}_{Cu} + ( 1 - p ) {ε}_{air} )}{( ( 1 + p ) {ε}_{air} + ( 1 - p ) {ε}_{Cu} )}} .$$

The reflectance property as a function of the effective impedance can be determined with the Abele's Transfer Matrix approach of calculating the optical interference between the surrounding medium, virtual layer of the partially filled space, the underlying thin film, and the substrate.

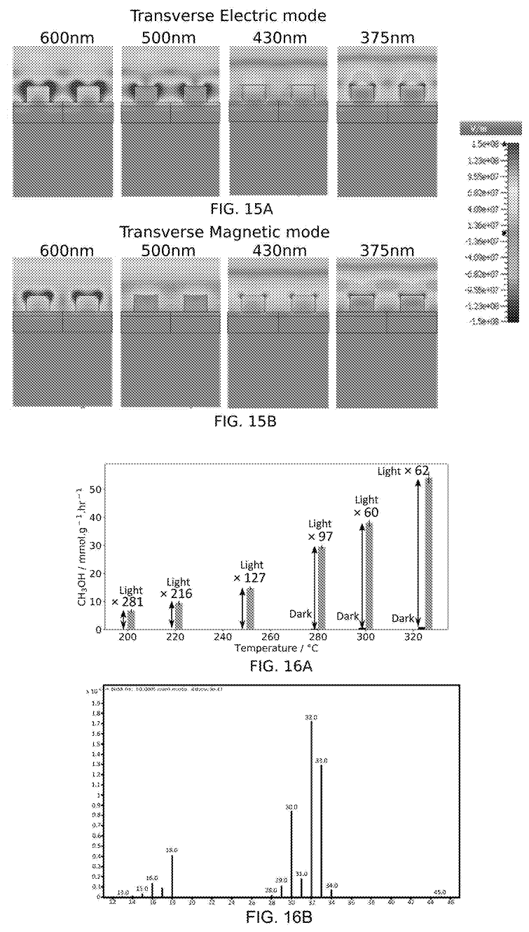

The plasmonic properties of an individual copper/zinc oxide block are shown in FIGS. 14A and 14B. The top view of the cube at 300, 400, 500 and 600 nm incident wavelength light is shown in FIG. 14A, which shows that at 500 nm and 600 nm incident light, the corners of the cube show strong localized surface plasmon resonance. The total electric field intensity of the simulation cell volume is represented in FIG. 14B, which shows that the intensity nearly doubles at 500 nm-700 nm incident wavelength range.

The plasmonic interaction between a pair of copper cubes is represented in FIGS. 15A and 15B. With Transverse Electric and Transverse Magnetic mode propagation of incident light, strong plasmonic coupling between the electric fields of each cube results in a cavity resonant mode. The strong electric field is also in the locality of the flat surfaces of the cubes, which indicates that the plasmonic resonance is not simply due to sharp corners. In addition, in the Transverse Magnetic mode results, there is also plasmonic coupling between the top surface of the cubes under 600 nm wavelength. In all, FIG. 15A and FIG. 15B indicates that the presence of strong electric fields interacting with the sides and corners of the copper cubes can likely induce hot carriers such as hot electrons, from all exposed surfaces of the cube. These hot electrons can tunnel into reactant molecules to excite them, which enables energetically favorable dissociation and further conversion into product molecules.

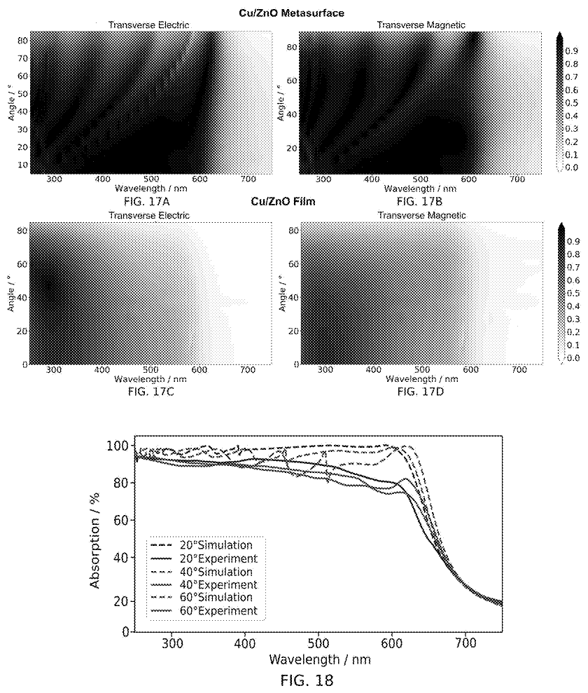

FIG. 16A shows the methanol production rate of the catalytic metasurface in dark and under photo-illumination. The hydrogenation of carbon dioxide over the copper/zinc oxide metasurface was carried out in a batch gas reactor with 4 atmospheres pressure of hydrogen gas and 1 atmosphere pressure of carbon dioxide under a range of reactor temperatures. The photo-illumination intensity was approximately 7 suns (716 mW/cm²). The methanol product was quantized via gas chromatography (SRI 8610), calibrated with a known quantity of methanol gas. Under white light, the methanol rate between dark and 7 suns illuminated metasurface is substantially enhanced by a factor of 127-281 at mild reactor temperatures of less than 260° C., whereas the nanoparticles on quartz fiber substrate only showed a 1.8-2.4 fold enhancement.

FIGS. 17A-17D show the optical absorption surface plot of the metasurface (FIG. 17A, B) and the uniform film (FIG. 17C, D) under Transverse Electric and Transverse Magnetic modes. For the uniform film plot of FIG. 17C, it can be seen that the optical absorption at the 500 nm-600 nm range drops off significantly with increasing incident angles from 40°. FIG. 17D shows that the optical absorption at the 200-400 nm range drops off with increasing angles from 50°. By contrast the plots associated with the metasurface show that the absorption stays relatively uniform from 0° to 60°, with the exception of several wavelength values. These plots show that a metasurface exhibits greater omnidirectionality absorption than that of a film.

FIG. 18 shows the optical absorption spectra of the simulated (dashed line) and experimental (solid line) metasurface at 20°, 40° and 60°. Both simulated and experimental results show that the absorption edge shifts slightly to a higher wavelength while absorption being essentially constant and exceeding an average value of 80% over the range of spectral interest at all angles.

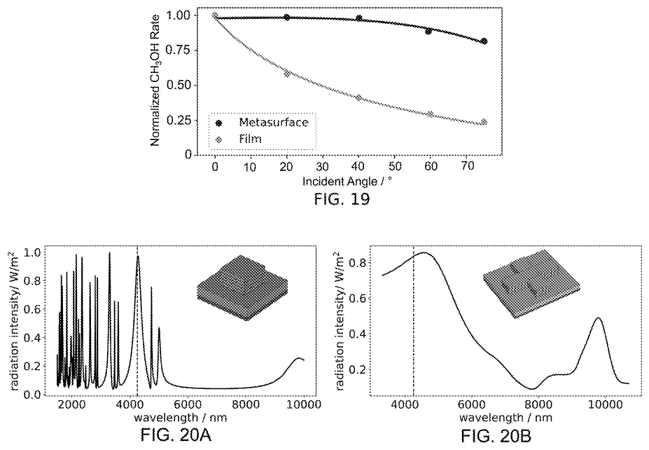

FIG. 19 shows the normalized methanol rate of the metasurface and uniform film under angular incident illumination. It can be seen that the methanol rate of the metasurface does not change noticeably until an incident angle of 60°-70° and yet exceeding 80%, whereas the methanol rate of the film drops almost linearly with increasing incident angles.

To analytically explain the insensitivity to angular incidence of light, the Effective Medium Theory approximation is again used to show that the impedance matching of the metasurface is achieved over a wide range of incident angles. As discussed in the prior section, the effective impedance of the material includes the impedance constant of vacuum. The impedance constant of vacuum can also vary with incident angle and incident polarization

$${Z}_{0}^{TE} = {Z}_{0} / cos {θ}_{i} and {Z}_{0}^{TM} = {Z}_{0} cos {θ}_{i}$$

where TE and TM represent Transverse Electric and Transverse Magnetic propagation modes, and θᵢ is the incident angle of wave propagation in vacuum. The effective impedance of the metasurface at angular incidence is modified from the impedance at perpendicular incidence as

$${Z}_{eff}^{TE} = {Z}_{eff} / cos {θ}_{eff} and {Z}_{eff}^{TM} = {Z}_{0} cos {θ}_{eff}$$

with θ_{eff} is the incident angle of wave propagation in relation to the normal of the metasurface layer. In order to achieve all-angle impedance matching, the effective impedance of the metasurface has to match the impedance of the surrounding medium, hence both the effective electric permittivity and magnetic permeability has to be approximately a value of one.

FIGS. 20A and 20B show two types of metamaterial structure periodic elements that are engineered to emit in a narrowband that can couple to the vibrational mode of CO₂ molecules. FIG. 20A shows a multilayer Nickel-SiO₂ metamaterial structure that does not have good photo-absorption but can be heated by convection or electrical heating. The resultant infrared emission is highly narrowband at 4.26 μm. FIG. 20B shows a multilayer Nickel-SiO₂ metamaterial structure shaped as a cross that has good photo-absorption with an average~80% absorption through the visible range, while engineered to have infrared emission close to 4.2 μm. These results show that it is possible to engineer high heat retention metamaterials that can be heated conventionally or by photothermal effects, while emitting in wavelengths that couple to reactant molecules for increased activation.

The specific embodiments have been shown by way of an example, and it should be understood that these embodiments may be subject to various modifications and alternative forms. It should be further understood that the claims are not intended to be limited to the particular forms disclosed, but rather to cover all modifications, equivalents and alternatives.

### REFERENCES

[1] J. Yu, J. Low, W. Xiao, P. Zhou, and M. Jaroniec, “Enhanced photocatalytic CO2-reduction activity of anatase TiO₂ by coexposed {001} and {101} facets,” J. Am. Chem. Soc, vol. 136 (25), pp. 8839-8842, 2014.
[2] Y. Li, W. N. Wang, Z. Zhan, M. H. Woo, C. Y. Wu, and P. Biswas, “Photocatalytic reduction of CO₂ with H₂O on mesoporous silica supported Cu/TiO₂ catalysts,” Appl. Cat. B: Env., vol 100 (1-2), pp. 386-392, 2010.
[3] M. M. J. Li, Z. Zeng, F. Liao, X. Hong, and S. C. E. Tsang, “Enhanced CO₂ hydrogenation to methanol over CuZn nanoalloy in Ga modified Cu/ZnO catalysts,” J. Cat., vol 343, pp. 157-167, 2016.
[4] Z. J. Wang, H. Song, H. Pang, Y. Ning, T. D. Dao, Z. Wang, H. Chen, Y. Weng, Q. Fu, T. Nagao, and Y. Fang, “Photo-assisted methanol synthesis via CO2 reduction under ambient pressure over plasmonic Cu/ZnO catalysts,” Appl. Cat. B: Env., vol 250, pp. 10-16, 2019.
[5] S. Neaţu, J. A. Maciá-Agulló, P. Concepción, and H. Garcia, “Gold-copper nanoalloys supported on TiO₂ as photocatalysts for CO₂ reduction by water,” J. Am. Chem. Soc., vol. 136 (45), pp. 15969-15976, 2014.
[6] T. A. Egerton, “UV-Absorption—The Primary Process in Photocatalysis and Some Practical Consequences,” Molecules, vol. 19 (11), pp. 18192-18214, 2014.
[7] G. Puma, “Modeling of Thin-Film Slurry Photocatalytic Reactors Affected by Radiation Scattering,” Env. Sci. Technol. Vol. 37, pp. 5783-5791, 2003.
[8] R. J. Brandi, M. A. Citroni, O. M. Alfano, A. E. Cassano, “Absolute quantum yields in photocatalytic slurry reactors,” Chem. Eng. Sci. vol. 58, pp. 979-985, 2003.
[9] P. G. O'Brien, K. K. Ghuman, A. A. Jelle, A. Sandhel, T. E. Wood, J. Y. Y. Loh, J. Jia, D. Perovic, C. V. Singh, N. P. Kherani, C. A. Mims and G. A. Ozin, “Enhanced photothermal reduction of gaseous CO₂ over silicon photonic crystal supported ruthenium at ambient temperature,” Energy Environ. Sci., vol. 11, pp. 3443, 2018.
[10] J. Dean, M. G. Taylor, G. Mpourmpakis, “Unfolding adsorption on metal nanoparticles: Connecting stability with catalysis,” Sci. Adv., vol. 5, 2019.
[11] S. Linic, U. Aslam, C. Boerigter and M. Morabito, “Photochemical transformations on plasmonic metal nanoparticles,” Nat. Mat., vol. 14, pp. 567-576, 2015.
[12] W. Cai, U.K. Chettiar, A. V. Kildishev, and V. M. Shalaev, “Optical cloaking with metamaterials,” Nat. Photonics, vol. 1 (4), pp. 224-227, 2007.
[13] D. R. Smith, J. B. Pendry and M. C. Wiltshire, “Metamaterials and negative refractive index,” Science, vol. 305 (5685), pp. 788-792, 2004.
[14] Z. Wang, X. Meng, S. H. Choi, S. Knitter, Y. L. Kim, H. Cao, V. M. Shalaev, and A. Boltasseva, “Controlling random lasing with three-dimensional plasmonic nanorod metamaterials,” Nano Letters, vol. 16 (4), pp. 2471-2477, 2016.
[15] M. Lapine, I. V. Shadrivov, D. A. Powell and Y. S. Kivshar, “Magnetoelastic metamaterials,” Nat. Materials, 11 (1), pp. 30-33, 2012.
[16] G. Ma, and P. Sheng, “Acoustic metamaterials: From local resonances to broad horizons,” Sci. Adv., vol. 2 (2), pp. 1501595, 2016.
[17] K. Bertoldi, V. Vitelli, J. Christensen and M. V. Hecke, “Flexible mechanical metamaterials,” Nat. Rev. Materials, vol. 2 (11), pp. 1-11, 2017.
[18] A. Poddubny, I. Lorsh, P. Belov, and Y. Kivshar, Hyperbolic metamaterials. Nature Photonics, vol. 7 (12), pp. 948-957, 2013.
[19] N. I. Landy, S. Sajuyigbe, J. J. Mock, D. R. Smith, and W. J. Padilla, “Perfect metamaterial absorber,” Phys. Rev. Lett., vol. 100 (20), pp 207402, 2008.
[20] M. Safari, Y. He, M. Kim, N. P. Kherani, and G. V. Eleftheriades, “Optically and radio frequency (RF) transparent meta-glass,” Nanophotonics, vol. 1, 2020.
[21] N. Mattiucci, M. J. Bloemer, N. Aközbek, and G. D'aguanno, “Impedance matched thin metamaterials make metals absorbing,” Scientific Reports, vol. 3 (1), pp. 1-11, 2013.
[22] K. Aydin, V. E. Ferry, R. M. Briggs, and H. A. Atwater, “Broadband polarization-independent resonant light absorption using ultrathin plasmonic super absorbers,” Nature Comm., vol. 2 (1), pp. 1-7, 2011.
[23] Y. Ra'Di, C. R. Simovski, and S. A. Tretyakov, “Thin perfect absorbers for electromagnetic waves: theory, design, and realizations,” Phys. Rev. Appl., vol. 3 (3), pp. 037001, 2015.
[24] M. Bakir, M. Karaaslan, F. Dincer, K. Delihacioglu, and C. Sabah, “Perfect metamaterial absorber-based energy harvesting and sensor applications in the industrial, scientific, and medical band,” Opt. Eng., vol. 54 (9), pp. 097102, 2015.
[25] P. Rufangura, and C. Sabah, “Wide-band polarization independent perfect metamaterial absorber based on concentric rings topology for solar cells application,” J. Alloys and Compounds, vol. 680, pp. 473-479, 2016.
[26] C. Qiu, J. Wu, R. Zhu, L. Shen, and B. Zheng, “Dual-band near-unity metamaterial absorber based on cylinder MoS2-dielectric arrays for sensors,” Opt. Comm., vol. 451, pp. 226-230, 2019.
[27] P. Yu, L. V. Besteiro, Y. Huang, J. Wu, L. Fu, H. H. Tan, C. Jagadish, G. P. Wiederrecht, A. O. Govorov, and Z. Wang, “Broadband metamaterial absorbers,” Adv. Opt. Mat., vol. 7(3), p. 1800995, 2019.

1. A catalytic metamaterial device comprising:
a substrate;
a reflective layer disposed on the substrate; and
a metasurface overlying the reflective layer, the metasurface comprising an array of catalytic metamaterial elements, each element having at least one sub-wavelength spatial dimension and arranged in a periodic or semi-periodic lattice, the metasurface configured to tailor an optical response of the device.

2. The device according to claim 1, wherein the metasurface is configured to provide a near-unity broadband optical absorption and/or an engineered narrowband thermal emission and to drive a catalytic conversion of reactant molecules.

3. The catalytic metamaterial device according to claim 1, wherein the catalytic metamaterial elements have a subwavelength thickness between about 50 nm and 2000 nm and a geometry selected from the group consisting of cubic, cylindrical, pyramidal, tapered-pyramidal, hexagonal, and pentagonal shapes.

4. The catalytic metamaterial device according to claim 3, wherein the catalytic metamaterial elements have a subwavelength thickness between about 50 nm and 500 nm.

5. The catalytic metamaterial device according to claim 3, wherein the catalytic metamaterial elements have a subwavelength thickness between about 500 nm and 2000 nm.

6. The catalytic metamaterial device according to claim 1, wherein the periodic or semi-periodic lattice arrangement has a configuration selected from the group consisting of square, hexagonal, rectangular, centered-rectangular, and oblique configurations.

7. The catalytic metamaterial device according to claim 1, wherein the substrate is a rigid or flexible substrate formed of a dielectric or metallic material and has a thickness greater than about 0.5 μm, the substrate comprising one or more materials selected from the group consisting of aluminum (Al), silver (Ag), gold (Au), tin (Sn), iron (Fe), tungsten (W), silicon (Si), silicon dioxide (SiO₂), silicon nitride (Si₃N₄), and aluminum oxide (Al₂O₃); and wherein the reflective layer is an optically reflective layer formed of a metallic or semiconductor material and has a thickness between about 1 nm and 500 nm, the reflective layer comprising one or more materials selected from the group consisting of aluminum (Al), silver (Ag), gold (Au), tin (Sn), iron (Fe), copper (Cu), nickel (Ni), stainless steel, silicon (Si), and germanium (Ge).

8. The catalytic metamaterial device according to claim 1, wherein each metamaterial element comprises at least one layer formed of a metallic material, a semiconductor material, or a material configured to perform electronic or catalytic functions, each layer being selected from the group consisting of: a catalytic layer configured to facilitate catalytic reactions; a functional layer configured to enhance reaction thermodynamics; and a layer configured to optimize mass-transfer processes.

9. The catalytic metamaterial device according to claim 1, wherein each metamaterial element comprises at least one layer formed of a metallic material, a semiconductor material, or a compound material configured to provide optical and catalytic functionality, each layer being configured to perform a distinct functionality selected from the group consisting of: optical absorption; thermal emission; charge separation; and charge transfer.

10. The catalytic metamaterial device according to claim 8, wherein each layer comprises at least one sublayer.

11. The catalytic metamaterial device according to claim 8, wherein each metamaterial element comprises more than two layers.

12. The catalytic metamaterial device according to claim 11, wherein the more than two layers comprise at least one layer configured to provide catalytic activity and another layer configured to provide electron or hole transport.

13. The catalytic metamaterial device according to claim 11, wherein at least two of the layers are formed from different materials.

14. The catalytic metamaterial device according to claim 1, wherein the metamaterial elements are decorated with catalytic species selected from the group consisting of: catalytic nanoparticles having diameters from about 1 nm to about 25 nm; molecular catalysts having sizes from about 10 Å to about 5 nm, selected from transition-metal complexes; and two-dimensional materials selected from graphene, graphene nitride, boron nitride, and transition-metal dichalcogenides.

15. The catalytic metamaterial device according to claim 8, wherein the layers of the metamaterial elements are formed of a material selected from the group consisting of:
elemental metals selected from the group consisting of aluminum (Al), silicon (Si), titanium (Ti), vanadium (V), chromium (Cr), iron (Fe), cobalt (Co), nickel (Ni), copper (Cu), zinc (Zn), molybdenum (Mo), rhodium (Rh), palladium (Pd), silver (Ag), tin (Sn), tungsten (W), iridium (Ir), platinum (Pt), gold (Au), lead (Pb), indium (In), gallium (Ga), manganese (Mn), bismuth (Bi), ruthenium (Ru), and tantalum (Ta), and combinations thereof;
metal alloys selected from the group consisting of cobalt-platinum (Co—Pt), tungsten-copper (W—Cu), nickel-iron (Ni—Fe), aluminum-nickel (Al—Ni), nickel-silicon (Ni—Si), gallium-palladium (Ga—Pd), palladium-silver (Pd—Ag), platinum-ruthenium (Pt—Ru), gold-indium (Au—In), iron-cobalt (Fe—Co), tungsten-nickel-platinum (W—Ni—Pt), platinum-tin-ruthenium (Pt—Sn—Ru), platinum-tin-nickel (Pt—Sn—Ni), iron-copper-aluminum (Fe—Cu—Al), copper-manganese-cobalt (Cu—Mn—Co), copper-gallium-zinc (Cu—Ga—Zn), and silver-indium-zinc (Ag—In—Zn), and combinations thereof;
semiconductors and semiconductor compounds selected from the group consisting of silicon (Si), germanium (Ge), gallium arsenide (GaAs), silicon-germanium (SiGe), germanium telluride (GeTe), gallium (Ga), arsenic (As), selenium (Se), and antimony (Sb);
metal compounds selected from the group consisting of oxides, nitrides, and sulphides of any of the foregoing metals, including titanium oxide (TiO₂), zinc oxide (ZnO), copper oxides selected from the group consisting of Cu₂O, CuO, and CuO₂, iron oxide (Fe₂O₃), cerium oxide (CeO₂), chromium oxide (Cr₂O₃), tin oxide (SnO₂), tungsten oxide (WO₃), molybdenum sulphide (MoS₂), and bismuth sulphide (Bi₂S₃), and complex or mixed oxides and sulphides including zinc germanate (Zn₂GeO₄), titanium-tin oxide (Ti/SnO₂), zinc-titanium silicate (Zn—Ti/SiO₂), and chromium-titanium silicate (Cr—Ti/SiO₂); and
doped semiconductors exhibiting infrared plasmonic response selected from the group consisting of indium tin oxide (ITO), vanadium dioxide (VO₂), boron-doped silicon, nitrogen-doped silicon, phosphorus-doped silicon, and doped zinc oxide (ZnO).

16. The catalytic metamaterial device according to claim 8, wherein each metamaterial element comprises more than three layers, the layers including a p-type hole-donating semiconductor layer, an intrinsic semiconductor layer, and an n-type electron-donating semiconductor layer forming a p-i-n junction configured to absorb broadband light under photo-illumination, effect charge-carrier separation with reduced recombination, and inject electrons and holes to drive, respectively, reduction and oxidation of reactant molecules.

17. The catalytic metamaterial device according to claim 7, wherein the multilayer element comprises a charge-transfer arrangement selected from the group consisting of a Z-scheme, an S-scheme, a Type I straddling-gap heterojunction, a Type II staggered-gap heterojunction, and a Type III broken-gap heterojunction, the arrangement being configured to enable recombination of photogenerated carriers at one or more internal interfaces to produce excess holes at a surface layer and excess electrons adjacent to the reflective layer, thereby facilitating catalytic oxidation and reduction reactions.

18. The catalytic metamaterial device according to claim 1, wherein localized surface plasmonic resonances occur at corners, edges, or steps of the metamaterial elements and surface plasmon polaritons are supported by the reflective layer.

19. The device according to claim 1, wherein the metasurface exhibits near-unity optical absorption, defined as at least about 80%, over a wavelength band of about 300-1500 nm and across incident angles from 0° to about 70°.

20. A catalytic metamaterial device comprising:
a substrate;
a reflective layer disposed on the substrate; and
a metasurface overlying the reflective layer, the metasurface comprising an array of catalytic metamaterial elements, each metamaterial element having one or more spatial dimensions smaller than a wavelength of interest, the array being arranged in a periodic or semi-periodic lattice configuration to tailor the optical response of the device.

21. A catalytic metamaterial device comprising:
a substrate;
a reflective layer disposed on the substrate; and
a metasurface overlying the reflective layer, the metasurface comprising an array of catalytic metamaterial elements, each element having at least one sub-wavelength spatial dimension and arranged in a periodic or semi-periodic lattice configuration, the metasurface being configured to provide near-unity optical absorption across a broadband of wavelengths and a range of incident angles and polarizations and/or to exhibit engineered narrowband thermal emission, while simultaneously promoting catalytic conversion of reactant molecules through photothermal and/or charge-mediated mechanisms.

22. A method of promoting a catalytic reaction using the catalytic metamaterial device according to claim 1, the method comprising irradiating and/or resistively heating the metasurface to activate the catalytic metamaterial elements by a mechanism selected from the group consisting of:
photothermal heating arising from broadband near-unity optical absorption of light over a wide range of wavelengths and incident angles, thereby elevating the temperature of the metamaterial elements to enhance the catalytic conversion of reactant molecules;
plasmonically mediated charge transfer induced by illumination that excites localized surface plasmon resonances and surface plasmon-polariton modes within or between the metamaterial elements, thereby generating energetic charge carriers and injecting electrons and/or holes into reactant molecules adsorbed on the metasurface to drive oxidation and reduction reactions; and
selective vibrational excitation of reactant molecules through narrowband infrared emission from the metasurface that is spectrally matched to a vibrational transition of the reactant while suppressing parasitic thermal emission outside that spectral band, thereby enhancing catalytic selectivity and efficiency.

23. A method of making a catalytic metamaterial device comprising:
providing a substrate;
depositing, on the substrate, a reflective film formed of a metallic or semiconductor material having optical reflectivity to incident radiation;
forming, on the reflective film, a metasurface comprising an array of catalytic metamaterial elements arranged in a periodic or semi-periodic lattice, each element having at least one sub-wavelength spatial dimension and including one to three layers, or more than three layers; and
selecting and controlling the composition, geometry, and spatial arrangement of the catalytic metamaterial elements so as to tailor an optical response of the device, including near-unity broadband optical absorption and/or engineered narrowband thermal emission, while maintaining catalytic functionality of the metamaterial elements.
